(19) United States
(12) Patent Application Publication
(10) Pub. No.: US 2026/0013415 A1
(43) Pub. Date: Jan. 15, 2026

(54) AGRICULTURAL WORK MACHINE OPERATION MONITORING SYSTEMS AND METHODS

(71) Applicant: Deere & Company, Moline, IL (US)

(72) Inventors: Nathan R. VANDIKE, Geneseo, IL (US); Nikhil N. ANANDWADE, Kolhapur (IN); Noel W. ANDERSON, Fargo, ND (US)

(21) Appl. No.: 19/231,138

(22) Filed: Jun. 6, 2025

Related U.S. Application Data
(60) Provisional application No. 63/670,436, filed on Jul. 12, 2024.

(51) Int. Cl. A01B 79/00; A01D 41/127; G06T 7/00

(52) U.S. Cl. CPC A01B 79/005; A01D 41/1271; A01D 41/1278; G06T 7/0006; G06T 2207/30188

(57) ABSTRACT

An agricultural system includes one or more processors and memory storing instructions executable by the one or more processors. The instructions, when executed by the one or more processors, configure the agricultural system to: obtain an image captured by an imaging device during an agricultural operation performed by an agricultural work machine, the image indicating a characteristic; segment the image to generate a segmented image having a plurality of cells and selectively size each cell of the plurality of cells according to one or more cell size criteria; determine one or more values of the characteristic based on the segmented image; and control an operating parameter of the agricultural work machine based, at least, on the one or more values of the characteristic.

### CROSS-REFERENCE TO RELATED APPLICATION

The present application is based on and claims the benefit of U.S. Provisional Patent Application Ser. No. 63/670,436 filed, Jul. 12, 2024, the content of which is hereby incorporated by reference in its entirety.

### FIELD OF THE DESCRIPTION

The present description relates to agricultural work machine operations. More specifically, the present description relates to agricultural work machine operations, monitoring characteristics relative to the agricultural work machine operation, and controlling an agricultural work machine.

### BACKGROUND

There are a wide variety of different types of agricultural work machines. One such example agricultural work machine is an agricultural harvester (also called harvester) that performs, as an agricultural work machine operation, harvesting in which the harvester is used to harvest various crops, such as different types of grain crops, at a worksite (e.g., field). A harvester can include, among other things, residue monitoring systems to capture images of crop residue generated by the harvester and used to adjust a subsequent field operation based upon an analysis of the images.

The discussion above is merely provided for general background information and is not intended to be used as an aid in determining the scope of the claimed subject matter.

### SUMMARY

An agricultural system includes one or more processors and memory storing instructions executable by the one or more processors. The instructions, when executed by the one or more processors, configure the agricultural system to: obtain an image captured by an imaging device during an agricultural operation performed by an agricultural work machine, the image indicating a characteristic; segment the image to generate a segmented image having a plurality of cells and selectively size each cell of the plurality of cells according to one or more cell size criteria; determine one or more values of the characteristic based on the segmented image; and control an operating parameter of the agricultural work machine based, at least, on the one or more values of the characteristic.

One or more techniques and systems are described herein for crop harvest monitoring. In one implementation, a crop harvest monitoring system comprises an imaging device configured to acquire at least one image relating to a crop harvest. The crop harvest monitoring system further comprises an analyzing unit configured to segment the plurality of images to determine one or more crop harvest characteristics using a segmentation grid having a plurality of cells, wherein one or more cells of the plurality of cells have a size different than one or more other cells of the plurality of cells. The analyzing unit is further configured to set the sizes of the plurality or cells based on an operational characteristic. The crop harvest monitoring system also comprises a control unit configured to generate a control signal to adjust an operation associated with a crop harvesting operation based at least in part on the determined one or more crop harvest characteristics.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

The examples disclosed herein may take physical form in certain parts and arrangement of parts, and will be described in detail in this specification and illustrated in the accompanying drawings which form a part hereof and wherein:

FIG. 1 is a block diagram illustrating a crop harvest characteristic monitoring system according to an implementation.

FIG. 2 illustrates a segmentation grid according to an implementation.

FIG. 3 illustrates an image showing obscured regions according to an implementation.

FIG. 4 is an example of a method for managing field operations according to an implementation.

FIG. 5 is a diagram illustrating a camera mounting arrangement for a crop harvest monitoring system according to an implementation.

FIG. 6 is a partial pictorial, partial schematic illustration showing an example harvester.

FIG. 7 is a block diagram of one example crop harvest characteristic monitoring system.

FIG. 8 is a block diagram of an example computing environment suitable for implementing various examples.

FIG. 9 is a block diagram showing one example of items of a crop harvest characteristic monitoring system in communication with a remote server architecture.

FIGS. 10, 11, and 12 show examples of mobile devices that can be used in a crop harvest characteristic monitoring system.

FIG. 13 is a block diagram showing one example of a computing environment that can be used in a crop harvest characteristic monitoring system.

### DETAILED DESCRIPTION

For the purpose of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example can be combined with the features, components, and/or steps described with respect to other examples of the present disclosure.

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form to facilitate describing the claimed subject matter.

The methods and systems disclosed herein, for example, may be suitable for use in different harvesters and harvesting applications. That is, the herein disclosed examples can be implemented in different harvesters other than for particular types of crops and/or harvesting systems (e.g., other than for specific combine harvester vehicles for particular harvesting applications, such as for particular grain harvesting) to analyze a performance of the harvester, including residue performance such as residue spread quality, residue chopping quality, residue distribution quality, residue size (or other residue quality parameters) that results in improved performance to determine when operational changes are needed. For example, one or more herein described examples allow for improved analysis of harvester performance that more effectively and accurately informs a control system as to the actual performance of a harvester sub-system, such as a residue system. As such, improved real-time harvester subsystem adjustments can be made, such as based on performance data that has been stored for later use as described in more detail herein. In some examples, while the analysis of the images can be difficult in some circumstances or conditions, such as resulting from obscurants or environmental conditions, thereby affecting the evaluation of a characteristic of interest (e.g., residue performance of the crop residue. For instance, cameras and other types of optical sensors may not be able to penetrate obscurants to allow for proper performance evaluation. One or more examples herein are able to make appropriate performance evaluations and adjustments even in these circumstances and conditions.

It should be appreciated that one or more examples described herein can be implemented in connection with any type of characteristic in the agricultural harvesting processing, including before processing of the crop, during processing of the crop, or after processing of the crop, as well as using different types of operational characteristics or parameters (e.g., confidence value, obscurant level, etc.). That is, the present disclosure contemplates systems and arrangements used in processed and/or not processed agricultural environments or applications (e.g., processed crop applications or pre-processed crop applications).

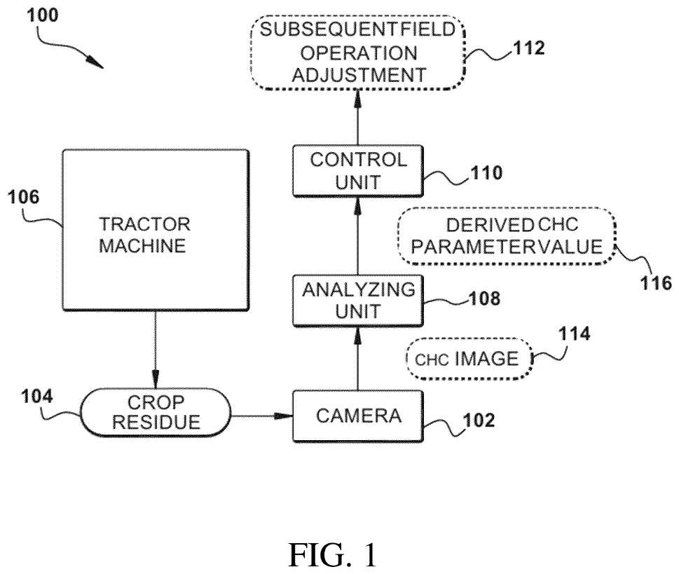

FIG. 1 illustrates an example characteristic monitoring system, illustratively referred to as crop harvest characteristic monitoring system 100 that allows for improved determination of one or more characteristics (e.g., crop harvest characteristics), such as the residue performance (e.g., spread and/or distribution performance) of a residue system for an agricultural work machine in the form of a tractor machine 106. The crop harvest characteristic monitoring system 100 in some examples utilizes an imaging device, such as a camera 102, to capture one or more images (e.g., one or more images of the crop residue 104 generated by the tractor machine 106). It should be noted that any sensor or imaging system capable of sensing or imaging residue material can be used.

The crop harvest characteristic monitoring system 100 further includes a processing unit, such as an analyzing unit 108 (e.g., a crop residue quality processing system) that determines or derives a data quality metric value (e.g., corresponding to a level of confidence or other characteristic), such as for (or corresponding) to a crop harvest characteristic (e.g., crop residue parameter, such as residue performance, of the crop residue) based upon an optical analysis of the image (that has, at least in some examples, been segmented into a plurality of cells (or the like)), which then can be used to control the operation of the tractor machine 106. In one example, a control unit 110 utilizes the data quality metric value (e.g. confidence level) as well as a performance metric (e.g., residue performance metric such as a residue spread quality metric) for the imaged crop residue to adjust a subsequent field operation 112 (e.g., generate a control signal to adjust one or more residue system operating parameters or other operating parameters). As a result, the subsequent field operations may be adjusted for improved system performance based on the current crop residue conditions (e.g., current residue performance). That is, in some examples, improved determination of the residue performance (e.g., residue spread or distribution performance), particularly in the presence of obscurants, allows for improved control of the tractor machine 106 (e.g., improved control of the residue system operation).

In various examples, the tractor machine 106 is an agricultural machine that separates crop plants from the growing medium and processes the crop plants to separate the targeted portion of the crop plant, such as grain, from unwanted portions of the crop plant, such as straw, chaff or other crop residue. In one implementation, the tractor machine 106 is a combine harvester that separates grain, such as corn, wheat, oats or the like from the remaining crop residue 104 using a threshing mechanism and a cleaning mechanism. The threshing mechanism may include a straw walker or threshing rotor. The cleaning mechanism may include a chaffer or sieve through which the grain falls and from which the crop residue, such as straw are chaff, is blown rearwardly for discharge and spreading. In some implementations, the tractor machine 106 additionally includes a chopper which chops the crop residue prior to this discharge, and can be controlled in accordance with one or more examples.

In one or more examples, the camera 102 captures images of the crop residue 104 generated by the tractor machine 106. In one implementation, the camera 102 captures the image of the crop after the crop has been discharged and spread by the tractor machine 106. It should be noted that the camera 102 can be any type of imaging device (e.g., infrared imaging, thermal imaging, radar, lidar, etc.) and can be provided by, for example, a satellite, drone, tillage machine or other platform separate from the tractor machine 106 generating the crop residue. In some implementations, the camera 102 used to capture the image(s) of the crop residue 104, prior to discharge or after discharge from the tractor machine 106, is coupled to the tractor machine 106. For example, in some implementations, the camera 102 is located to capture images of the crop residue 104 as the crop residue 104 is being blown from a sieve or chaffer towards a rear residue spreader of the tractor machine 106. In some implementations, the camera 102 is located to capture images of the crop residue 104 as the crop residue 104 is being directed from a straw walker or threshing rotor towards a rear residue spreader of the tractor machine 106. In some implementations, the camera 102 is located to capture images of the crop residue 104 after the crop residue 104 has undergone chopping, but before the chopped crop residue 104 has been spread by the rear residue spreader of the tractor machine 106. In some other implementations, the camera 102 is located to capture images of the crop residue 104 after the crop residue 104 has been discharged. In some implementations, the camera 102 is located to capture images in front of the tractor machine 106. In some implementations, multiple cameras 102 are utilized to capture images of the crop residue 104 at more than one of the above described stages. These are merely some examples of the locations and fields of view of camera 102 and are described with reference to residue monitoring. In other examples, camera 102 can be mounted at various other locations with various other fields of view to captures images of other characteristics of interest.

As should be appreciated, depending on the level or amount of obscurants (e.g., dust obscurants), the cameras(s) 102 may not be able to view all of the crop residue or crop to be harvested (e.g., camera or other optical sensor may not be able to penetrate obscurants). One or more implementations can be provided in connection with different characteristics relating to different harvesting operations, and the herein described implementations are merely examples.

One or more implementations can be used in an operating environment that includes obscurant. In one example, the obscurant is heavy dust, which is produced by the tractor machine 106 during task performance within the operating environment. However, it should be noted that dust is merely an example, and the obscurant may also be fog, smoke, snow, rain, ash, or steam, among other obscurants, within the operating environment. Additionally, it will be noted that the obscurant (e.g., dust), can be generated by another machine, other than the tractor machine 106, such as another machine operating within the operating environment. The obscurant prevents the imaging sensor (e.g., the camera 102) from acquiring images 114 that allow for the detection of, different characteristics, properties, features, etc. in the captured images 114.

It should be noted that the operating environment in some examples also includes one or more topographical features. In one example, the topographical feature is a hill or an upgrade in the terrain of the operating environment. However, the topographical feature may also be any feature that reduces or limits the effectiveness of the sensing or imaging of the characteristic of interest (e.g., characteristics of the crop residue, such as residue performance). In other words, the topographical feature may prevent the camera from imaging (e.g., properly imaging the crop residue behind the tractor machine 106).

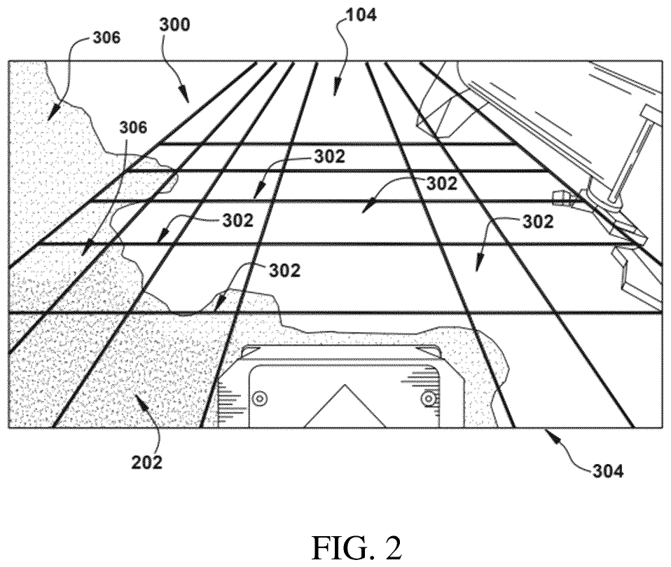

One or more examples use a segmentation grid 300 (see FIG. 2) configured as a variable sized image segmentation grid, comprising cells, which may have different sizes, as described in more detail herein to improve the analysis of the images 114, particularly under obscurant conditions. That is, the segmentation grid 300, that segments the image into cells, allows for a more effective and accurate determination of a characteristic, such as the residue performance (e.g., residue spread quality, such as spread width quality, or residue distribution quality) of the crop residue from the tractor machine 106 in one particular example. As can be seen in the image 304 of FIG. 2 that shows crop residue 104, cells 302 of the segmentation grid 300 have different sizes that are dynamically adjustable and selected based on one or more criteria (e.g., cell size criteria) or determinations as described in more detail herein. In the image 304, the obscurant 306, namely dust obscurant (e.g., dust obscurant from the crop residue) is present in some of the cells 302 and obscures the image pixels within at least these cells 302.

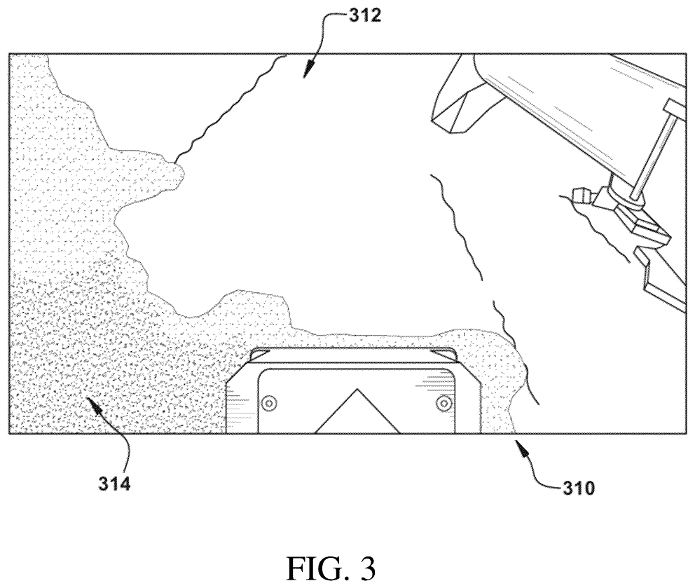

FIG. 3 illustrates an image 310 that is a pictorial representation of image pixels 312 of crop residue that are visible and not obscured, and image pixels 314 of crop residue that are obscured (i.e., imaged obscurant). It should be noted that some of the cells 302 (see FIG. 2) are completely obscured and some of the cells 302 are partially obscured, while other cells 302 are completely visible. Thus, the image pixels 312 represent image data captured by the camera 102 within the operating environment that does not include the obscurant and the image pixels 314 represent image data captured by the camera 102 within the operating environment that include the obscurant. That is, image data with the obscurant represents image data where crop residue is obscured or partially obscured. Image data with the obscurant illustrates the effects of an obscurant, such as heavy dust, on the image data captured by the camera 102, particularly the image quality to detect the crop residue and thus, the residue performance.

With reference again to FIG. 1, in one or more examples, the analyzing unit 108 is or includes a processing unit configured (e.g., programmed with instructions contained on a non-transitory computer-readable or machine-readable medium) to analyze the segmented image(s) to determine a residue performance (e.g., residue spread quality or residue distribution quality). The analyzing unit 108 receives one or more captured crop harvest characteristic (CHC) image(s) 114 acquired by the camera 102 and determines or derives a value 116 for a CHC of the crop residue (e.g., a residue performance value such as a residue spread quality value or residue distribution quality value) based upon an optical analysis of the image(s) 114, for example, by dividing the image into the variable sized image elements or cells 302 (e.g., a segmented grid having different sized cells). The CHC for which the value 116 is determined or derived includes, but is not limited to, residue performance, such as at least one of chop size, crop residue moisture, crop residue constituents and crop residue dispersion (e.g., residue spread width, residue distribution, etc.). It should be noted that the image(s) 114 can be divided into the cells 302 (e.g., cells 302 of the segmentation grid 300) using different types of segmenting processes or sequences, such as (i) based on occluded, partial occluded, and non-occluded; (ii) based on an importance to the operation, among others; (iii) or based on other cell size criteria described herein. Thus, one or more examples provide variable segmentation of images that allow for adjusting a one or more operating parameters of the machine based on crop harvest characteristics and quality metrics (e.g., confidence levels) corresponding to the images, as described in more detail herein. The segmenting in various examples allows for improved analyzing of different areas of the field of view (e.g., segment to identify areas and analyze areas, such as using an optical analysis).

Further, in some examples (e.g., depending on the characteristic of interest) each portion (e.g., cell) of an image may have a respective characteristic value and the image may have an overall (e.g., aggregated) characteristic value. For instance, with regard to residue performance, such as residue spread width quality, each portion (e.g., cell) of the image may have a respective residue performance value (e.g., residue spread width value) and the image can have an overall (e.g. aggregated) residue performance value (e.g., residue spread width value). The overall value may represent the actual performance. For example, the spread width value of each portion of a number of portions of the image across a width of the image (e.g. corresponding to the header or cut width of the machine) may be aggregated (e.g., additively combined) to generate an overall residue spread width value representing the spread width of the crop residue dispersed by the machine.

In one implementation, the values 116 may be determined or derived by the analyzing unit 108 to optically identify individual pieces of crop residue and determine confidence values in identifying the individual pieces of crop residue 104. For example, the analytical or analyzing unit may measure a length of multiple pieces (or groups of pieces) of crop residue, wherein value of the crop harvest characteristic is the value 116 of the crop residue 104 parameter and may be based upon a count of the number of pieces having each of a plurality of lengths, and having an associated confidence level. As described in more detail herein, one or more implementations the analyzing unit can dynamically change the segmented element or cell sizes, such that the segmentation grid 300 used to analyze the image(s) 114 includes elements or cells 302 of different (and variable) sizes. Using this configuration, the analyzing unit 108 analyzes the images 114 that are segmented using the segmentation grid 300 and determines or derives a confidence value of or corresponding to the characteristics (and values 116) sensed. The confidence value can be used by the control unit 110 in some examples to determine whether a change in performance is occurring and to adjust the operation (e.g., the subsequent field operation adjustment 112) or machine operating parameters in response to changes in the crop harvest characteristic (e.g., residue performance) based at least in part by the analysis of a change in the crop harvest characteristic (e.g. residue performance) in combination with the one or more confidence values. For example, in one or more implementations, the analyzed images 114 have confidence values associated with one or more portions of the segmentation grid 300, thereby improving crop harvest characteristic value (e.g., residue performance value, such as residue spread quality value or residue distribution quality value) determination.

In some implementations, and merely describing one example, the analyzing unit 108 determines or derives different confidence values for the crop harvest characteristic (e.g., residue performance) across portion of discharged crop residue 104. Such information may be linked to geo-referenced data (acquired through a geo-referencing system such as GPS based geo-referencing system) to form a crop harvest characteristic map (e.g., a residue performance field map) that may be used for adjusting substantive field operations. For example, with respect to a residue performance, a first portion of discharge crop residue 104 may have a first determined or derived value (e.g., residue performance value) determined using cells 302 having a first size while a second portion of the discharge crop residue 104 may have a second determined or derived value (e.g., residue performance value) different than the first determined or derived value using cells 302 having a second size different than the first size. In some examples, the sizes of the cells 302 are determined in part based on a corresponding confidence in the image data. In other example, the sizes of the cells, as described elsewhere herein, may be determined in part based on other cell size criteria, other than, or in addition to, confidence.

By determining or deriving different geo-referenced residue performance values across portions of discharged crop residue, and using confidence values to assign a data quality metric value, field operations are adjusted based upon information having a higher degree of accuracy, thereby improving subsequent residue performance (e.g., residue spread quality or residue distribution quality). By determining or deriving different geo-referenced crop harvest characteristic values (e.g., residue performance values) at different points in time as a tractor machine (e.g., harvester) traverses a field, and using confidence values to assign a data quality metric value, subsequent field operations may be adjusted to accommodate changing conditions even as a tractor machine (e.g., harvester) moves across a field. It should be noted that the confidence values can be provided with different crop residue parameter value calculations, different types of image analysis, different operating parameters, etc.

In one or more examples, the control unit 110 includes a processing unit that adjusts subsequent field operation 112 based at least in part on data quality metrics (e.g., confidence values) corresponding to the images 114 of the crop residue 104. That is, the control unit 110 performs control operations in some examples based on a confidence evaluation or analysis using the segmentation grid 300. In one implementation, the control unit 110 is part of a different agricultural machine, other than the tractor machine 106 that carries out the subsequent field operation 112. In one implementation, the subsequent field operation 112 adjusted by the control unit 110 may include subsequent operations to the same geo-referenced regions by different agricultural machines other than the tractor machine 106. For example, subsequent tillage settings for tillage machines may be adjusted based upon the value 116 of the crop harvest characteristic. Subsequent spraying or planting operations may be adjusted based upon the value 116 of the crop harvest characteristic and/or an associated data quality metric (e.g., confidence level) at different geo-referenced locations or regions. In some implementations, the settings of the agricultural machine having the control unit 110 may remain the same, but the parameter of a subsequent applied material may be adjusted by the control unit 110 based upon the value of the crop harvest characteristic and/or an associated data quality metric (e.g., confidence level). For example, a type, density or other characteristic of seed, of applied herbicide, of applied insecticide, of applied fertilizer or of other applied materials may be adjusted based upon the value 116 of the crop harvest characteristic and/or an associated data quality metric (e.g., confidence level).

In some implementations, the control unit 110 may be part of the tractor machine 106. The control unit 110 in some examples adjusts the operating settings (e.g., operating parameters) of the tractor machine 106 during a subsequent harvesting season, during the same harvesting season, or during the same pass of the tractor machine 106 across the same field, based upon the value 116 of the crop harvest characteristic and/or an associated data quality metric (e.g., confidence level). For example, one or more operating settings (e.g., operating parameters) of the tractor machine 106 may be adjusted minutes or hours after the value 116 for the crop harvest characteristic value and/or an associated data quality metric (e.g., confidence level) has been determined or derived, while the tractor machine 106 is traversing the same field, based upon the determined or derived CHC parameter value 116 and/or an associated data quality metric (e.g., confidence level). Examples of such operating settings include, but are not limited to, chopper speed, tractor machine (e.g., harvester) travel speed, tractor machine (e.g., harvester) feed rate, chopper counter knife position, header height, spreader speeds, spreader vane positions, threshing speed, cleaning speed, threshing clearance, sieve louver positions, as well as a variety of operating settings. In some implementations, the different determined or derived CHC parameter values 116 and/or an associated data quality metric (e.g., confidence level) may be displayed to an operator (such as within the cab of the tractor machine 106), wherein the operator may make additional or alternative manual adjustments to the tractor machine 106 during harvesting. It should be noted that a pass may refer to a same pass, a different pass (e.g., an adjacent or overlapping pass), etc.

In yet other implementations, the control unit 110 is a remote controller that provides control signals to the tractor machine 106 and/or the other agricultural machine. The control unit 110 utilizes the determined or derived CHC parameter value 116 and/or an associated data quality metric (e.g., confidence level) to output control signals adjusting the subsequent field operation 112. In some implementations, the control unit 110, as part of the tractor machine 106 or as a remote controller, utilizes the determined or derived CHC parameter value 116 and/or an associated data quality metric (e.g., confidence level) output by the analyzing unit 108 to generate a field map linking different geo-referenced regions to different CHC parameter values 116 and/or an associated data quality metric (e.g., confidence level). For example, the tractor machine 106 may carry a geo-referencing device, such as a global positioning satellite transceiver, wherein the determined or derived crop residue parameter values (e.g. residue performance values) and/or an associated data quality metric (e.g., confidence level) received from the analyzing unit 108 are linked to the associated location or region of the field as provided by the geo-referencing device. The generated crop residue (e.g., residue performance) field map may be used as a basis for adjusting or controlling subsequent field operations 112 to the particular geo-referenced regions.

In one or more examples, the control unit 110 performs control operations based on the quality of the assessment or analysis in combination or conjunction with the assessment or analysis (e.g., confidence in the signal being plotted or mapped). During operation of the tractor machine 106, the residue performance (e.g., size of straw residue) created by the tractor machine 106 may be difficult to determine based on the operational environment (e.g., amount of obscurant) and the sensor types used. For example, measuring individual straw lengths can be difficult in the presence of obscurant, and even when the performance may be bordering on a threshold level, it can be challenging for control systems to determine when an operational change (e.g., operating parameter change) is needed. In one or more examples, a method of analysis for residue performance (e.g., residue spread quality or residue distribution quality) informs the control system 110 more effectively (with increased accuracy) as to the actual performance of the residue system by determining a change in residue performance (e.g., a change in residue spread quality or residue distribution quality) using the images 114 that are segmented and analyzed as described in more detail herein. The analysis for residue performance (e.g., residue spread quality or residue distribution quality) provides for managing field operations using improved CHC values 116 and/or associated data quality metrics (e.g., confidence levels). It should be noted that although examples are described in connection with the crop harvest characteristic monitoring system 100, one or more operations can be carried out by any of the other described implementations, including using different characteristics or criteria as described in more detail herein, such as with differently configured monitoring systems.

For example, in operation, the camera 102 captures images 114 of the crop residue 104 generated by the tractor machine 106. The images 114 may be captured at a point in time before or after discharge of the crop residue 104 by the tractor machine 106. In some implementations, the camera 102 may capture images of the crop residue 104 at multiple different locations inside of the tractor machine 106 as well as outside of the tractor machine 106. The images 114 may be captured by the camera 102 mounted to the tractor machine 106, by an airborne camera or by an agricultural machine that subsequently crosses the field. That is, in one or more examples, any type of imaging device can capture the images 114 of the crop residue 104, such as chopped straw material.

In one particular implementation, the camera 102 or other sensors (and associated processing of the sensor data) are configured in one or more examples to identify presence of material in the cells 302, such as using a binary assessment (e.g., material exists or does not exist), identify relative or percent amounts of material populating the cells 302, and/or a dust/obscurant level of the cells 302, among others. As described herein, a confidence value (or level) is assigned to the sensed material value in each cell 302 based on one or more of the dust/obscurant level, the detection of material in each cell 302, and/or the location of the cell 302 from the camera 102 (e.g., cells 302 farther from the camera 102 have a lower confidence value relative to a base confidence level), etc.

The analyzing unit 108 determines or derives the value 116 for the crop harvest characteristic (e.g., residue performance of the crop residue 104 generated by the tractor machine 106) based upon an optical analysis of the images 114 (e.g., images 114 of the crop residue 104). The crop harvest characteristic for which values may be determined or derived include, but are not limited to, residue performance, such as at least one of chop size, crop residue moisture, crop residue constituents and crop residue dispersion (e.g., residue spread width, residue distribution, etc.). In one implementation, the values may be determined or derived by the analyzing unit 108 by optically identifying individual pieces of the crop residue 104 and determining values for the individual pieces of crop residue 104 with a corresponding confidence level. For example, the analyzing unit 108 may measure a length of each of the pieces of crop residue 104, wherein the value 116 of the crop harvest characteristic may be based upon a count of the number of pieces having each of a plurality of lengths.

It should be noted that in one or more implementations, the value 116 comprises a numerical statistic such as average residue/straw length and can have an associated confidence value (e.g., indicating a confidence in the value 116). In another implementation, the value 116 comprises a categorization of the crop residue such as a type of crop residue, percent of different types of crop residue found in the image or the like and an associated confidence value. In another implementation, the value 116 comprises a categorization of the crop residue in terms of processing of the crop residue as described in more detail herein, such as under processed, over processed, or ideally processed, and the like, and an associated confidence value, wherein the “processing” refers to the degree to which the crop residue has been changed or reduced in size by the tractor machine 106. As should be appreciated, the value 116 can relate or correspond to any characteristic, for instance any crop harvest characteristic such as an agricultural characteristic, a machine characteristic, a performance characteristic, and/or a crop characteristic, among others. Additionally, as explained elsewhere herein, the value 116 can have an associated data quality metric (e.g., confidence level).

In implementations where the value 116 comprises a numerical statistic, the value 116 may be determined or derived by optically identifying individual pieces of the crop residue 104, individual pieces of straw, chaffer and the like in measuring a characteristic of the individual pieces, such as the length of the individual pieces using optical analysis that incorporates or uses a confidence level or value for the image analysis. Such identification may be carried out by applying various optical filters to the image(s) 114 to distinguish between individual pieces and then measuring the individual pieces using the detected edges of the individual pieces and the scale of the image(s) 114 being analyzed. The statistical value may be generated by counting the various pieces of a given length range or other sized range. The statistical value may be output or may be compared against a threshold (e.g., defined threshold value), wherein data quality metrics (e.g., confidence levels) are assigned or associated to the cells 302 of the segmentation grid 300. As will be described in more detail herein, a confidence level using the different sized cells 302 is also determined. That is, a probability of the accuracy (e.g., confidence level) of the crop harvest characteristic analysis is determined in various examples, such as by using different confidence criteria. As such, by analyzing images using associated confidence values (e.g., to adjust sizes of the cells 302), a more accurate crop harvest characteristic (e.g. residue performance) can be determined.

In one or more examples, in operation, sets of the images 114 that have been analyzed using the control unit 110 are used to determine one or more residue performance metrics that correspond to residue that is processed. For example, one or more implementations determine crop residue spread/distribution for control or documentation using the camera 102. It should be appreciated that the system 100 is sensor type agnostic and a field of view includes a width of the harvest and a length of the harvest (for at least some historical distance). For example, the field of view is divided into the variable size areas (e.g., variable sized cells 302 of the segmentation grid 300) to increase resolution in certain areas, such as the edge of cut (e.g., center of field of view needs less resolution). The size (e.g., length, width, etc.) of the cells 302 are variable as described herein and in one or more examples are determined based on various cell size criteria such as at least one or more of:
(1) Obscurant level—image areas with less obscurant can have larger cells 302 (less resolution);
(2) Material flow rate variability—higher variability requires higher resolution. Each cell 302 has a physical location (e.g., GPS location) with an assigned property of residue performance (e.g., residue spread or residue distribution);
(3) Presence of residue, percentage coverage, etc.; and
(4) Confidence value of the properties sensed—wherein confidence is determined by one or more confidence criteria such as obscurant level, distance from sensor, etc.

Thus, the size (length and/or width) of a cell may be dynamically and selectively varied based on the amount of obscurant in the area corresponding to the cell, the variability of a characteristic, such as material flow rate, (e.g., smaller cells for higher variability), the presence of residue/percentage coverage (e.g., smaller cells when residue is present as compared to when it is not, smaller cells when higher percentage coverage than as compared to lower percentage coverage), as well as the confidence value corresponding to the cell. As described the confidence value corresponding to a given cell and thus, corresponding to the crop harvest characteristic (e.g., residue performance) value of the given cell, can be based on a number of criteria such as the level of obscurants, the distance of the cell away from the sensor, as well as other confidence criteria. For example, cells may be reduced in size when confidence is lower and may be increased in size when confidence is higher.

In some examples, the analyzing unit 108 determines a cell property (e.g., residue performance) and confidence level as the tractor machine 106 moves along the field, wherein the cells 302 are updated (e.g., values, such as residue performance values, associated with the cells 302 are changed or adjusted) based on confidence levels. A control map can be generated based on the analyzed images of the crop harvester characteristic (e.g., residue performance of crop residue) and/or an associated data quality metrics (e.g., confidence levels).

The value(s) (e.g., value(s) of the CHC characteristic and the confidence value(s)) are input to the control unit 110, which is used to determine whether a change in the characteristic (e.g., residue performance) is occurring, and to adjust the characteristic (e.g., residue performance), such as by adjusting one or more machine operating parameters, in response to the changes in the characteristic determined by the analysis of the crop residue. For example, the control unit 110 may adjust the subsequent field operation 112 based upon the input values, such as the values 116 of the residue performance and associated confidence levels as described in more detail herein. For example, as the imaged field of view clears from dust obscurant, values 116 can be assigned different confidence levels.

In one implementation, the subsequent field operations 112 adjusted by the control unit 110 may comprise subsequent operations to the same geo-referenced regions by different agricultural machines other than the harvester. For example, subsequent tillage settings (e.g. operating parameters) for tillage machines may be adjusted based upon the values (e.g., value(s) of the CHC characteristic and the confidence value(s)). Subsequent spraying or planting operations (e.g. operating parameters thereof) may be adjusted based upon the values (e.g., value(s) of the CHC characteristic and the confidence value(s)) at different geo-referenced locations or regions.

In some implementations, the settings (e.g. operating parameters) of the agricultural machine, such as the tractor machine 106, may remain the same, but the operating parameters of a subsequent applied material operation or tillage operation may be adjusted based upon the values (e.g., value(s) of the CHC characteristic and the confidence value(s)). For example, a type, density or other characteristic of seed, of applied herbicide, of applied insecticide, of applied fertilizer or of other applied materials may be adjusted based upon the values (e.g., value(s) of the CHC characteristic and the confidence value(s)). In yet other implementations, the operating settings (e.g. operating parameters) of the tractor machine 106 during a subsequent harvesting season, during the same harvesting season or during traversal of the harvester across the same field may be adjusted based upon the values (e.g., value(s) of the CHC characteristic and the confidence value(s)) as described in more detail herein.

It should be noted that as the location of the cell 302 moves farther from the camera 102, in some examples, multiple cells 302 are combined in either the lateral direction or direction of travel (e.g., field of view and angle to farther distances reduces the ability to have smaller cell sizes at farther distances). The combining in some examples is determined based on the confidence values in the cells 302 determined previously when a better point of view was available and if the confidence values are high (e.g., meet or exceed a threshold value), the cells 302 are not combined to establish a higher resolution. It should also be noted that one or more examples operate to evaluate the material presence in cells 302 that may have a sensor value (e.g., CHC value such as a residue performance value) and a confidence level already assigned, and if the georeferenced cell 302 has a new, higher confidence value than the previous values assigned, then the cell value (e.g., crop harvest characteristic value, such as a residue performance value) is updated. The confidence values can be updated based on, for example, a threshold value and locations in a previous pass can be updated to have better visibility to a crop harvest characteristic (e.g., residue performance such as residue spread performance) on a subsequent pass. In some examples, the confidence values of near-neighbor/surrounding cells 302 are used to assess and update cells 302 with lower confidence levels that are in proximity thereto, such as based on interpolations (may be by combining values such as by aggregating values of higher confidence cells with values of lower confidence cells to update the values of the lower confidence cells).

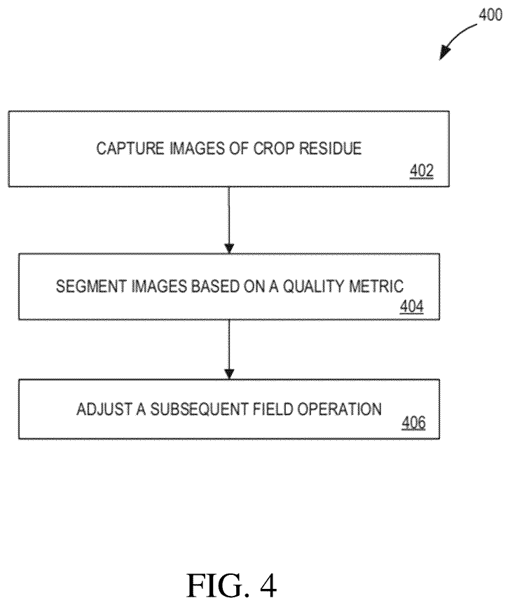

FIG. 4 is a flow diagram of an example method 400 for managing field operations using crop harvest characteristic information (e.g. residue performance information), such as controlling operation of a work machine (e.g., the tractor machine 106) at a work site. The method 400 is described in the context of being used in connection with the crop harvest characteristic monitoring system 100. However, it should be appreciated that method 400 may likewise be carried out by any of the other described implementations (e.g., performed using one or more configurations described in more detail herein) and with any crop harvest characteristic and is not limited to crop residue and residue performance. The method includes capturing one or more images of a crop harvest characteristic, such as images of residue performance of crop residue at operation 402. For example, one or more of the images 114 of the crop residue 104 generated by the tractor machine 106 are captured by the camera 102. The image(s) 114 may be captured at a point in time before or after discharge of the crop residue 104 by the tractor machine 106. In some implementations, as described herein, the camera 102 may capture the images 114 of the crop residue 104 at multiple different locations inside of the tractor machine 106 as well as outside of the tractor machine 106 (e.g., in front of the tractor machine 106).

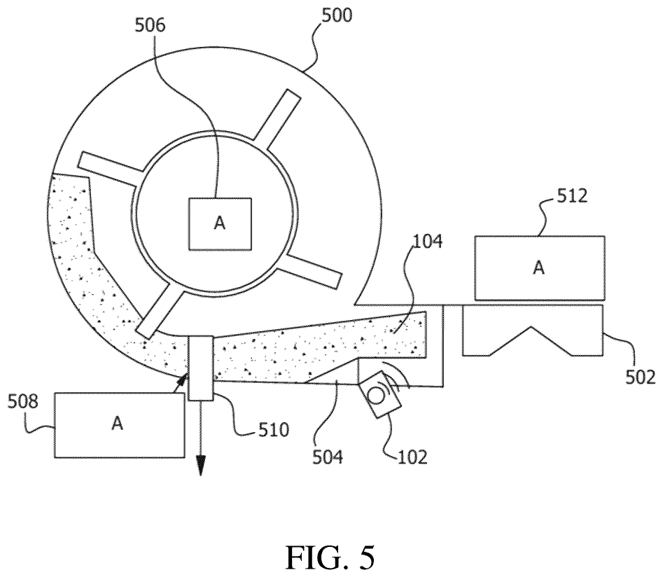

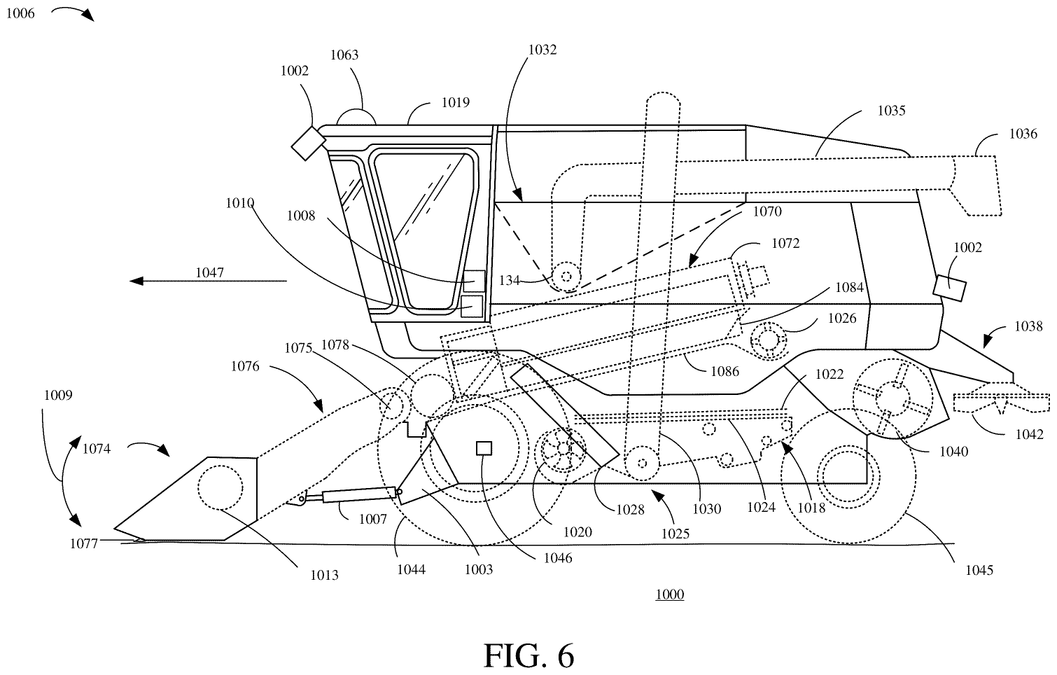

For example, as illustrated in FIG. 5, the camera 102 can be supported by a frame of the tractor machine 106 so as to be focused on interior regions of tractor machine 106 to capture images of crop residue 104 being blown from chaffer/sieve towards a chopper 500 and a spreader 502. In this example, the camera 102 is supported by the frame so as to focused on interior regions of the tractor machine 106 between the chopper 500 and the spreader 502. The camera 102 captures images of crop residue 104 after being chopped by the chopper 500 and prior to being discharged and spread by the spreader 502. In this example, the camera 102 is supported between the chopper 500 and the spreader 502 downstream of a deflector 504. The deflector 504 comprises a ramp or other structure that directs the flow of crop residue 104 over and above the camera 102, reducing direct impacts with the camera 102 and protecting the camera from the damaging flow of crop residue 104. In other examples, the camera 102 can be mounted in other positions or orientations, such as at the rear of the tractor machine 106 (e.g., as shown in FIG. 6) or in the front or side of the tractor machine 106 (as shown in FIG. 6), as well as other location internal or external to the tractor machine 106.

In addition to providing an image depicting the constitution of the crop residue 104 (or other parameters), the camera 102 provides an image that may be used to determine the residue performance characteristics (e.g., spread, distribution) of crop residue 104 on the ground. In the example illustrated, the crop residue 104 is spread by the spreader 502 in a row tailing from the tractor machine 106 as the tractor machine 106 traverses a field.

As described herein, images produced by the camera 102 may be used by the control unit 110 to identify different characteristics, as well as to identify the different constituents and different values for crop residue performance parameters. The control unit 110 in some examples may output control signals to different components, such as an actuator 506 (such as a hydraulic or electric motor) so as to adjust the speed of the chopper 500. In some examples, the control unit 110 may additionally or alternatively output control signals to an actuator 508 (such as a hydraulic cylinder or a solenoid) to adjust the position of a chopper counter knife 510 as indicated by the arrow, wherein the positioning affects the degree to which the residue is chopped by chopper 500. In some examples, the control unit 110 may additionally or alternatively output control signals to an actuator 512 (such as a hydraulic or electric motor) to adjust the speed of spreader 502 or the positioning of vanes of the spreader 502. In some examples, the control unit 110 may additionally or alternatively output control signals to adjust other operating parameters, such as adjusting the header height, adjusting a threshing speed, separation speed, threshing clearance or sieve louver positions, and/or adjusting the travel speed of the tractor machine 106 crossing a field or the rate at which crops are fed through tractor machine 106 by the various augers, conveyors and components of tractor machine 106, among others.

Referring again to FIG. 4, the method includes, at operation 404, segmenting the acquired images based on cell size criteria such as a quality metric (e.g., confidence level) or one or more other cell size criteria, such as an obscurant level (e.g., amount or percentage of obscurant) in different regions of the images 114 corresponding to different cells 302 of the segmentation grid 300, as well as other cell size criteria mentioned herein. In some examples, the segmentation includes having cells 302 of different sizes (that are variable) based on a confidence value that the pixels in the cells 302 show crop residue and not obscurant. For example, the confidence value in some examples is determined based on one or more of the obscurant level and the distance of the cell from the camera 102. In some examples, the images 114 are segmented into image elements defined by the cells 302 based on at least one obscurant threshold (e.g., is the quality of the image portions good or degraded, such as based on an optical density). That is, the images 114 or portions thereof may be degraded by the obscurant 202, resulting in no data, reduced confidence data, or high confidence data. The cells 302 in some examples are assigned a corresponding data quality metric (e.g., confidence level or value). In various examples, the data quality metric is an indication of the quality of the segments in different parts of the images 114, namely in the different cells 302. The data quality metric in some examples is saved with the residue performance (e.g., residue spread or residue distribution) indicator map. In some examples, the segmented images 114 are also stored (e.g., stored to a data store).

Additionally, it will be understood that in some examples, the entire image is segmented (i.e., every part of the image is assigned to a cell) and every cell is analyzed to determine a characteristic of interest. In some examples, the entire image is segmented (i.e., every part of the image is assigned to a cell) and only some of the cells are analyzed to determine a characteristic of interest.

In other examples, only some of the image is segmented (i.e., less than entirety of the image is assigned to a cell) and every cell is analyzed to determine a characteristic. Thus, in such examples, less than the entirety of the image (i.e., only the part of the image that is segmented) is analyzed to determine a characteristic of interest.

How an image is segmented (i.e., whether every part of the image is segmented or whether less than entirety of an image is segmented) and which cells are analyzed can be based on the characteristic of interest, the field of view of the sensor, as well as various other criteria.

In various examples, a plurality of locations in the images 114 are identified or correspond to the cells 302 of variable size, wherein the size of the cells 302 can be determined by, for example, based on one or more cell size criteria such as the relative location of the cell 302 relative to the cut width of the tractor machine 106 and/or other factors. In one or more examples, the cut width is determined through one or more of: fixed values related to operating parameters of the tractor machine 106, entered by a user, communicated from vehicle attachment parameters (e.g., a header controller identifying a width thereof), among others. Detection of a cut edge of the harvest operation (e.g., determining the edge of standing crop and cut crop) can be determined by different methods (e.g., lidar, radar, imaging), such as geometrical comparisons, or image classification and contrast methods. In some examples, the sizes of the cells 302 near the cut edge distance have a narrower width (relative to a machine lateral direction) to increase resolution of the detection. At least one cell 302 extends from the edge of the cut width beyond the operating width of the tractor machine 106 in some examples. The size of the cells 302 in some examples is further determined by, as a cell size criterion, the proximal distance from rear of the tractor machine 106 in the direction of travel, by, as a cell size criterion, the level of obscurant that exists during the operation, and/or by, as cell size criterion, the amount of variability in a characteristic, such as material flow rate as detected by sensors (such as rotor drive pressure sensors, knifebank load sensors, grain flow rate sensors, vehicle speed sensors, etc.) as described in more detail herein. It should be noted that in various examples higher variability in material flow rates requires smaller (e.g., shorter distance or length) cells 302 to correspond with the need to detect and document more variability. The cells 302 are also defined as having a physical location on a field based on the GPS signal in various examples.

The cells 302 in some examples are additionally or optionally assigned a corresponding vegetative matter metric. For example, one or more of a crop metric, a weed metric, a soil metric, a residue metric (e.g., residue performance metric), etc. can be assigned to the cells 302.

In some examples, the image data can be back-filled when more accurate (e.g., higher confidence) data is available or the image data can be interpolated. It should be noted that the processing of the images 114 can include a sideways looking or overlapping assessment from a next pass of the tractor machine 106. For example, a last pass across the field by the tractor machine 106 that had images of low confidence can updated using an analysis of the images 114 from a next pass (e.g., in a different direction) and that may have image portions that overlap with the previous pass. In some examples, side and rear images are evaluated and the image that is least obscured is selected or, as discussed, images, or portions of the images (e.g., cells) of higher confidence are combined (e.g., interpolated) with images, or portions of images (e.g., cells), of lower confidence.

In some examples, a default value is substituted for a sensed value of an attribute (e.g., crop harvest characteristic) derived from the image, such as based at least in part on when a data quality value (e.g., confidence value) does not satisfy a defined quality (e.g., confidence) threshold value. The default value is then used to control the tractor machine 106. For example, if conditions behind a combine become excessively dusty, a distribution control is performed using a default setting (e.g., fixed or pre-defined setting based on default value) rather than variable settings based on real-time image data.

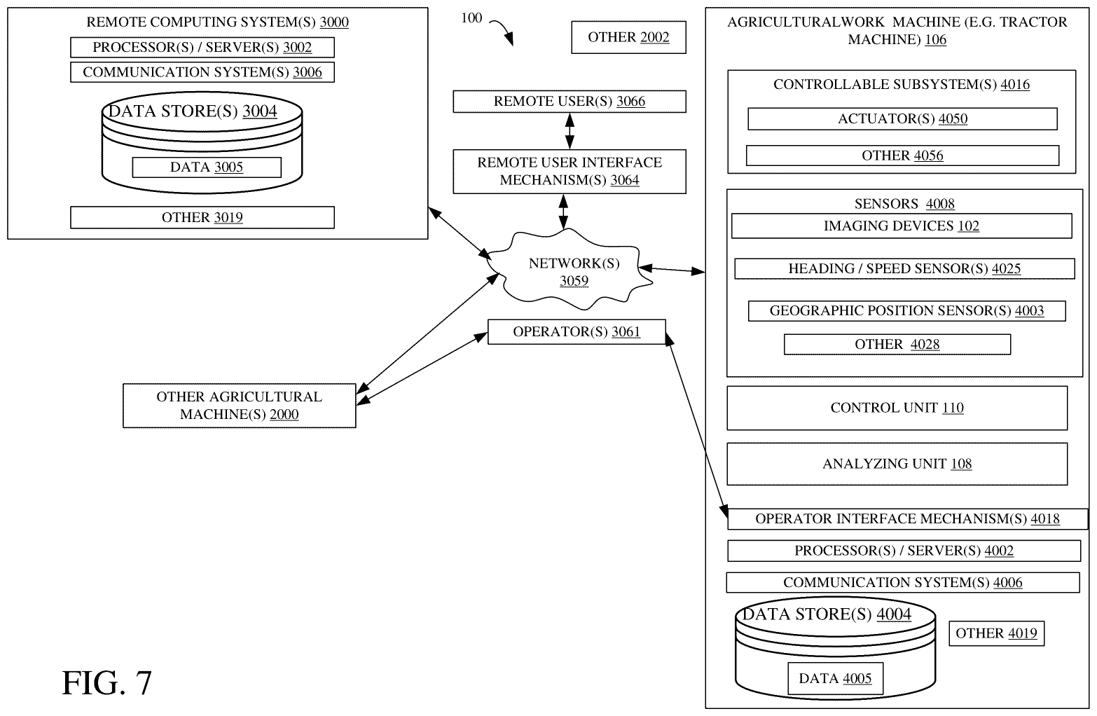

In some examples, at operation 404, the information is displayed to a user (e.g., operator of the tractor machine 106). The information may be displayed on a screen or a user interface of the tractor machine 106 (e.g., 4018 of FIG. 7), such as displaying the segmented images, control maps (e.g., residue performance maps), confidence values, etc. Different types of information can be displayed and configured or formatted as desired or needed. For example, an indication of image quality (e.g., confidence level or value) is displayed in some examples as a separate layer or above a performance indicator layer (e.g., residue performance indicator layer). In some examples, the confidence level or value is shown at the same time or in connection with the cells 302 of the segmentation grid 300.

The sizes of the cells 302 can be automatically adjusted based on, as a cell size criterion, the confidence levels in some examples (e.g., dynamically adjusted). In other examples, the sizes of the cells 302 can be manually adjusted. In some examples, an initial size of the segmentation grid 300 and the cells 302 is set (e.g., set a targeted cell size), such as based on, as cell size criteria, historical data, user preference, current environment conditions, pre-set or default cell sizes, etc., which is then adjusted as described in more detail herein (e.g., based on the processed image that factor in changes in the environment, such as changes in the level of obscurant or other cell size criteria). In some examples, cell sizes are adjusted based on preset or fixed intervals, based on conversions (e.g., cell size criteria to cell size, or cell size adjustment criteria), a lookup table, learned adjustments (e.g., machine learned, etc.), models, manual selection, or various other processes. It should be noted that any cell geometric parameters (e.g., size) can be set or adjusted, such at least one of a length, a width, an angle, an area, a radius, or a combination thereof, of a cell, among others.

In some examples, image regions that are obscured in a real-time evaluation, can be replaced by a different view (e.g., view from an adjacent pass) that allows for assessment without obscurant (e.g., dust obscurant). As discussed elsewhere herein, in some examples, image regions that are obscured in real-time evaluation can be interpolated with a different view (e.g., view from an adjacent pass) that allows for assessment without obscurant (e.g., dust obscurant).

For example, portion(s) (e.g., cell(s)) of an image, can be replaced by portion(s) (e.g., cell(s)) of another image based on confidence levels, or particular criteria such as the level of obscurant. For instance, a first image may have portion(s) (e.g., cell(s)) having a relatively low confidence level (e.g., relative to a threshold) and those portion(s) can be replaced by portion(s) of second image (e.g., image from an adjacent pass, subsequent image of the same pass, etc.) having a higher confidence level. In another example, other criteria, other than confidence level may be used to determine image portion replacement. For example, a first image may have portion(s) (e.g., cell(s)) having a relatively high level of obscurant (e.g., relative to a threshold) and those portion(s) can be replaced by portion(s) of a second image (e.g., image from an adjacent pass, subsequent image of the same pass, etc.) having a lower level of obscurant. The replacement portion(s) (e.g., the portion(s) of the second image replacing the portion(s) of the first image) correspond to the same geographic area of the worksite as the portion(s) they are replacing. This replacement results in the generation of a new (e.g., stitched image) having portion(s) of multiple images (e.g., portion(s) of both a first and second image). The new (e.g., stitched image) may be used in the determination of values 116 (e.g., residue performance values) and may also have corresponding confidence levels and can be used in the adjustment of a subsequent field operation.

At operation 406, a subsequent field operation is adjusted, which may be immediately after or at a later time. For example, the control unit 110 adjusts a subsequent field operation based upon the segmented images as described in more detail herein. The tractor machine 106 or other work machine can be controlled based on image processing that is performed as the tractor machine 106 is performing one or more operations. In some examples, the subsequent field operation causes a change in one or more operating parameters for residue performance (e.g., operating parameters for residue spread or residue distribution), or other crop harvest characteristics relative to the operation of tractor machine 106. That is, the same residue performance is not always desired, depending on the conditions,, and in one or more examples, the field operation is adjusted based on a target performance level (e.g., a user defined or user input optimal residue performance, such as optimal length). As such, the residue performance is adjusted appropriately for the conditions, type of crop, subsequent harvesting, etc. In some examples, filtering can be performed based on the characteristics of the residue to, for example, adjust a sensitivity of the probability trend analysis.

The subsequent field operation is controlled in some examples by generating a signal for the control unit 110 to control a subsystem of the tractor machine 106. In various examples, the subsystems include, for example, a map generation/recording system, and a residue system, and/or a propulsion system, among others, including others discussed elsewhere herein. The signals to communicate the spread locations relative to the cut width/desired width include, for example, distances, offsets, map forms, performance scores (e.g., amount at target, variability in performance of the spread both laterally and in the direction of travel), etc. It should be noted that variability evaluations in some examples are performed between the cells in all directions. In some examples, the control systems described herein perform control functions related to one or more subsystems based on one or more of the residue performance values within a cell 302, variability, cell sizes, and confidence levels, among others.

Thus, the herein described systems and methods determine a crop harvest characteristic such as residue performance (e.g., crop residue spread quality or crop residue distribution quality) that allows for improved control or documentation by dividing the field of view (e.g., an imaged field of view) into variable size areas, which allows for changing the resolution in certain areas. On the fly or dynamic changes can be made based on changes in the determined confidence level as the harvester moves along the field (e.g., updating image regions (cells) based on confidence levels).

FIG. 6 is partial pictorial, partial schematic illustration of an example agricultural work machine or tractor machine in the form of an agricultural harvester 1006 (also called harvester 1006). Harvester 1006 is one example of tractor machine 106. In the example shown in FIG. 6, harvester 1006 is in the form of a combine harvester. As illustrated in FIG. 6, harvester 1006 includes ground engaging traction elements 1044 and 1045 which can be driven by a propulsion subsystem (e.g., internal combustion engine, electric motors, hydrostatic drive, and other drivetrain elements, such as a gear box) to propel harvester 1006 across a worksite 1000 (e.g., a field). While, in the example of FIG. 6, ground engaging traction elements 1044 and 1045 are shown as wheels and tires, in other examples, elements 1044 or 1045, or both, could be other forms of ground engaging traction elements such as track systems. Harvester 1006 includes an operator compartment or cab 1019, which can include a variety of different operator interface mechanisms (e.g., 4018 shown in FIG. 7) for controlling harvester 1006 as well as for presenting (e.g., displaying, etc.) various information. Harvester 1006 includes a feeder house 1076, a feed accelerator 1078, and a thresher generally indicated at 1070. The feeder house 1076 and the feed accelerator 1078 form part of a material handling subsystem 1025. Header 1074 is pivotally coupled to a frame 1003 of harvester 1006 along pivot axis 1075. One or more actuators 1007 drive movement of header 1074 about axis 1005 in the direction generally indicated by arrow 1009. Thus, a vertical position of header 1074 (the header height) above worksite 1000 over which the header 1074 travels is controllable by actuating actuators 1007. While not shown in FIG. 6, agricultural harvester 1006 can also include one or more actuators that operate to apply a tilt angle, a roll angle, or both to the header 1074 or portions of header 1074.

Agricultural harvester 1006 includes a material handling subsystem 1025 that includes a thresher 1070 which illustratively includes a threshing rotor 1072 and a set of concaves 1084. Further, material handling subsystem 1025 also includes a separator 1086. Agricultural harvester 1006 also includes a cleaning subsystem or cleaning shoe (collectively referred to as cleaning subsystem 1018) that includes cleaning fan(s) 1020, chaffer 1022, and sieve 1024. The material handling subsystem 1025 also includes discharge beater 1026, tailings elevator 1028, and clean grain elevator 1030. The clean grain elevator moves clean grain into a material receptacle (or clean grain tank) 1032.

Harvester 1006 also includes a material transfer subsystem that includes a conveying mechanism 1034 and a chute 1035. Chute 1035 includes a spout 1036. In some examples, spout 1036 can be movably coupled to chute 1035 such that spout 1036 can be controllably rotated to change the orientation of spout 1036. Conveying mechanism 1034 can be a variety of different types of conveying mechanisms, such as an auger, blower, or belted conveyor. Conveying mechanism 1034 is in communication with clean grain tank 1032 and is driven (e.g., by an actuator, such as motor or engine) to convey material from grain tank 1032 through chute 1035 and spout 1036. Chute 1035 is rotatable through a range of positions from a storage position (shown in FIG. 6) to a variety of deployed positions away from agricultural harvester 1006 such as to align spout 1036 relative to a material receptacle of a material receiving machine that is configured to receive the material within grain tank 1032. Spout 1036, in some examples, is also rotatable, by an actuator, to adjust the direction of the material stream exiting spout 1036.

Harvester 1006 also includes a residue subsystem 1038 that can include, among other things, residue chopper 1040 and residue spreader 1042. Residue chopper can be similar to or the same as residue chopper 500. Residue spreader 1042 can be similar to or the same as residue spreader 502. Residue subsystem 1038 can include various other items as well such as a counter knife similar to or the same as counter knife 510, a deflector similar to or the same as deflector 504, and actuators similar to or the same as actuators 506, 508, 512

In some examples, a harvester within the scope of the present disclosure can have more than one of any of the subsystems mentioned above. In some examples, harvester 1006 can have left and right cleaning subsystems, separators, etc., which are not shown in FIG. 6.

In operation, and by way of overview, harvester 1006 illustratively moves through a worksite (e.g., field) 1000 in the direction indicated by arrow 1047. As harvester 1006 moves, header 1074 engages the crop plants to be harvested and cuts, with a cutter bar 1077 on the header 1074, the crop plants to generate cut crop material.

The cut crop material is engaged by a cross conveyor (e.g. cross auger, belts, etc.) 1013 which conveys the severed crop material to a center of the header 1074 where the severed crop material is then moved through an opening to a conveyor in feeder house 1076 toward feed accelerator 1078, which accelerates the severed crop material into thresher 1070. The severed crop material is threshed by rotor 1072 rotating the crop against concaves 1084. The threshed crop material is moved by a separator rotor in separator 1086 where a portion of the residue is moved by discharge beater 1026 toward the residue subsystem 1038. The portion of residue transferred to the residue subsystem 1308 is chopped by residue chopper 1040 and spread on the field by residue spreader 1042.

Grain falls to cleaning subsystem 1018. Chaffer 1022 separates some larger pieces of material other than grain (MOG) from the grain, and sieve 1024 separates some of finer pieces of MOG from the grain. The grain then falls to a conveyor (e.g., an auger, etc.) that moves the grain to an inlet end of grain elevator 1030, and the grain elevator 1030 moves the grain upwards, depositing the grain in grain tank 1032. Residue is removed from the cleaning subsystem 1018 by airflow generated by one or more cleaning fans 1020. Cleaning fans 1020 direct air along an airflow path upwardly through the sieves and chaffers. The airflow carries residue rearwardly in harvester 1006 toward the residue handling subsystem 1038 where it is chopped by residue chopper 1040 and spread on the field by residue spreader 1042.

Tailings elevator 1028 returns tailings to thresher 1010 where the tailings are re-threshed. Alternatively, the tailings also can be passed to a separate re-threshing mechanism by a tailings elevator or another transport device where the tailings are re-threshed as well.

Harvester 1006 can include a variety of sensors, some of which are illustrated in FIG. 6, such as one or more ground speed sensors 1046, one or more geographic position sensors 1063, and one or more imaging devices, such as cameras, 1002.

Ground speed sensors 1046 sense the travel speed of harvester 1006 over the ground. Ground speed sensors 1046 can sense the travel speed of the harvester 1006 by sensing the speed of rotation of the ground engaging traction elements 1044 or 1045, or both, a drive shaft, an axle, or other components. In some instances, the travel speed can be sensed using a positioning system (e.g., geographic position sensors 1063), such as a global positioning system (GPS), a dead reckoning system, a long-range navigation (LORAN) system, a Doppler speed sensor, or a wide variety of other systems or sensors that provide an indication of travel speed. Ground speed sensors 1046 can also include direction sensors such as a compass, a magnetometer, a gravimetric sensor, a gyroscope, GPS derivation, to determine the direction of travel in two or three dimensions in combination with the speed. This way, when harvester 1006 is on a slope, the orientation of harvester 1006 relative to the slope is known. For example, an orientation of harvester 1006 could include ascending, descending or transversely travelling the slope.

Geographic position sensors 1063 illustratively sense or detect the geographic position or location of harvester 1006. Geographic position sensors 1063 can include, but are not limited to, a global navigation satellite system (GNSS) receiver that receives signals from a GNSS satellite transmitter. Geographic position sensors 1063 can also include a real-time kinematic (RTK) component that is configured to enhance the precision of position data derived from the GNSS signal. Geographic position sensors 1063 can include a dead reckoning system, a cellular triangulation system, or any of a variety of other geographic position sensors.

Imaging devices 1002 capture images indicative of various crop harvest characteristics, such as such an agricultural characteristic, a machine characteristic, a performance characteristic (e.g., residue performance characteristic, such as residue spread quality or residue distribution quality, etc.), and/or a crop characteristic. among others. Imaging devices 1002 are examples of imaging devices or cameras 102. As shown, imaging devices 1002 can be located at various positions on harvester 1006. Imaging devices 1002 can be disposed to look at or observe various locations including locations around (e.g., ahead of, behind, etc.) harvester 1006 and locations internal to harvester 1006. The example locations of imaging devices 1002 are examples only. In other examples, imaging devices 1002 can be, additionally, or alternatively, disposed at various other locations including the other locations of imaging devices (e.g., 102) described herein.

As can be seen in FIG. 6, an imaging device 1002 is disposed to observe rearwardly of harvester 1006, such as to detect residue performance such as residue spread quality, residue distribution quality, as well as other residue performance characteristics.

FIG. 7 is a block diagram showing another example of crop harvest characteristic monitoring system 100 (hereinafter also referred to as system 100). System 100 includes agricultural work machine (e.g., tractor machine) 106. One example of tractor 106 is also shown as harvester 1006 in FIG. 6. System 100 also includes one or more remote computing systems 3000, one or more networks 3059, one or more remote user interface mechanisms 3064, one or more other machines 2000, and can include a variety of other items 2002 as well. Other agricultural machines 2000 can include any of a variety of other agricultural machines, such as other agricultural machines (e.g., tillage machines, spraying machines, planting machines, etc.) that perform other agricultural operations (e.g., tillage operations, spraying operations, planting operations, etc.) that may be subsequent to the operation (e.g., harvesting operation) performed by tractor machine 106. Examples of other agricultural machines and other agricultural operations have been previously described.

As shown in FIG. 7, tractor machine 106, itself, illustratively includes one or more processors or servers 4002, one or more data stores 4004, one or more communication systems 4006, one or more sensors 4008, analyzing unit 108, control unit 110, one or more controllable subsystems 4016, one or more operator interface mechanisms 4018, and can include various other items and functionality 4019 as well.

Remote computing systems 3000, as illustrated, include one or more processors or servers 3002, one or more data stores 3004, one or more communication systems 3006, and can include various other items and functionality 3019.

Data stores 3004 and data stores 4004 each store a variety of data (generally indicated data 3005 and data 4005 respectively), such as the various data described herein. Additionally, data 3005 can include computer executable (readable) instructions that are executable by one or more processors or servers 3002 to implement other items or functionalities of system 100, including other items of remote computing systems 3000. Additionally, data 4005 can include computer executable (readable) instructions that are executable by one or more processors or servers 4002 to implement other items or functionalities of system 100, including other items or functionalities of tractor machine 106. It will be understood that data stores 3004 and data stores 4004 can include different forms of data stores, for instance both volatile data stores (e.g., Random Access Memory (RAM)) and non-volatile data stores (e.g., Read Only Memory (ROM), hard drives, solid state drives, etc.). Though not shown in FIG. 7, it will be understood that each other agricultural machine 2000 can also include data stores similar to or the same as data stores 3004 or 4004 that store data similar to or the same as data 3005 or 4005.

Sensors 4008 can include one or more imaging devices 102, one or more heading/speed sensors 4025, one or more geographic position sensors 4003, and can include various other sensors 4028 as well. The sensor data (e.g., images, signals, etc.) generated by sensors 4008 can be communicated to remote computing systems 3000, to other agricultural machines 2000, and to other items of tractor machine 106.

Heading/speed sensors 4025 detect a heading characteristic (e.g., travel direction) or speed characteristic (e.g., travel speed, acceleration, deceleration, etc.), or both, of tractor machine 106. This can include sensors that sense the movement (e.g., rotation) of ground-engaging elements (e.g., 1044, 1045) or movement of components (e.g., axles) coupled to the ground engaging elements or other elements, or can utilize signals received from other sources, such as geographic position sensors. Thus, while heading/speed sensors 4025 as described herein are shown as separate from geographic position sensors 4003, in some examples, machine heading/speed is derived from signals received from geographic position sensors 4003 and subsequent processing. In other examples, heading/speed sensors 4025 are separate sensors and do not utilize signals received from other sources. One example of heading/speed sensors 4025 are sensors 1046 shown in FIG. 6.

Geographic position sensors 4003 illustratively sense or detect the geographic position or location of tractor machine 106. Geographic position sensors 4003 can include, but are not limited to, a global navigation satellite system (GNSS) receiver that receives signals from a GNSS satellite transmitter. Geographic position sensors 4003 can also include a real-time kinematic (RTK) component that is configured to enhance the precision of position data derived from the GNSS signal. Geographic position sensors 4003 can include a dead reckoning system, a cellular triangulation system, or any of a variety of other geographic position sensors. One example of geographic position sensors 4003 are geographic position sensors 1063 shown in FIG. 6.

Imaging devices, or cameras, 102 have been previously described. One example of imaging devices 102 are imaging devices 1002 shown in FIG. 6.

Sensors 4008 can also include various other types of sensors 4028, including other sensor described herein.

Analyzing unit 108 has been previously described herein. Control unit 110 has been previously described herein and can, among other things (as previously described), generate control signals to control one or more components of system 100, such as one or more components of tractor machine 106, such as controllable subsystems 4016 (e.g., to adjust operating parameters of the controllable subsystems 4016), interface mechanisms 4018, and communication system 4006.

As shown, controllable subsystems 4016 include one or more actuators 4050 as well as various other items 4056. Actuators 4050 include a variety of different types of actuators that control operating settings (e.g., operating parameters) of one or more components of tractor machine 106. Actuators 4050 can include actuators that control the position (e.g., height, depth, or spacing) or orientation (e.g., pitch, roll, yaw, etc.) of components of tractor machine 106 as well as actuators that control a speed of movement (e.g., speed of rotation, speed of reciprocation, etc.) of components of tractor machine 106. Actuators 4050 can include, without limitation, motors, valves, pumps, hydraulic actuators (e.g., hydraulic cylinders, etc.), pneumatic actuators (e.g., pneumatic cylinders, etc.), electric actuators (e.g., linear actuators, etc.), as well as various other types of actuators. Some examples of actuators 4050 have been previously shown and described herein, such as actuator 506, actuator 508, actuator 512, actuators 1007, as well as other actuators described herein. While not shown in FIG. 6, it will be understood that each other agricultural machine 2000 can include one or more actuators, similar to or the same as actuators 4050, that are controllable to adjust operational settings of the other agricultural machine 2000, such as by control unit 110 when a control unit 110 is disposed on the other agricultural machine 2000.

Communication systems 4006 are used to communicate between components of tractor machine 106, or with other items of system 100, such as remote computing systems 3000, other agricultural machines 2000, or user interface mechanisms 3064, or a combination thereof. Communication systems 3006 are used to communicate between components of a remote computing system 3000 or with other items of system 100, such as tractor machine 106, other agricultural machines 2000 other remote computing systems 3000, or user interface mechanisms 3064, or a combination thereof.

Communication systems 3006 and 4006 can both include one or more of wired communication circuitry and wireless communication circuitry, as well as wired and wireless communication components. In some examples, communication systems 3006 and 4006 can include one or more of a system for communicating over various networks, such as a communication system for communicating over the Internet, a cellular communication system, a system for communicating over a wide area network or a local area network, a system for communicating over a controller area network (CAN), such as a CAN bus, a system for communicating over a controller area network flexible data-rate (CAN-FD), such as a CAN-FD bus, a system for communication over a near field communication network, a system for communicating over ethernet, or a communication system configured to communicate over any of a variety of other networks. Communication systems 3006 and 4006 can both also include a system that facilitates downloads or transfers of information to and from a secure digital (SD) card or a universal serial bus (USB) card, or both. Communication systems 306 and 406 can both utilize network 3059. Networks 3059 can be any of a wide variety of different types of networks such as the Internet, a cellular network, a wide area network (WAN), a local area network (LAN), a controller area network (CAN), a controller area network flexible data-rate (CAN-FD), a near-field communication network, ethernet, or any of a wide variety of other networks.

While not shown in FIG. 7, it will be understood that each other agricultural machine 2000 can include communication systems similar to or the same as communications systems 4006 or 3006.

FIG. 7 shows that one or more operators 3061 can operate tractor machine 106 or other agricultural machines 2000. Operators 3061 interact with operator interface mechanisms, such as operator interface mechanism 4018. In some examples, operator interface mechanisms 4018 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, operators 3061 can interact with operator interface mechanisms 4018 using touch gestures. Additionally, at least some of the operator interface mechanisms 4018 can be used to present (e.g., display, audible presentation, haptic presentation, etc.) various information. The examples described above are provided as illustrative examples and are not intended to limit the scope of the present disclosure. Consequently, other types of operator interface mechanisms 4018 can be used and are within the scope of the present disclosure.

Additionally, in some examples, some operator interface mechanisms 4018 can be separate from (or separable from), but communicatively coupled to tractor machine 106.

While not shown in FIG. 7, it will be understood that each other agricultural machine 2000 can include operator interface mechanisms, similar to or the same as operator interface mechanisms 4018, and interactable by operators 3061.

FIG. 7 also shows remote users 3066 interacting with tractor machine 106, other agricultural machines 2000, and remote computing systems 3000 through user interface mechanisms 3064 over networks 3059. In some examples, user interface mechanisms 3064 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, the users 3066 can interact with user interface mechanisms 3064 using touch gestures. Additionally, at least some of the user interface mechanisms 3064 can be used to present (e.g., display, audible presentation, haptic presentation, etc.) various information. The examples described above are provided as illustrative examples and are not intended to limit the scope of the present disclosure. Consequently, other types of user interface mechanisms 3064 can be used and are within the scope of the present disclosure.

Remote computing systems 3000 can be a wide variety of different types of systems, or combinations thereof. For example, remote computing systems 3000 can be in a remote server environment. Further, remote computing systems 3000 can be remote computing systems, such as mobile devices, a remote network, a farm manager system, a vendor system, or a wide variety of other remote systems. In one example, tractor machine 106 and other agricultural machines 2000 can be controlled remotely by remote computing systems 3000 or by remote users 3066, or both. In some examples, operators 3061 are on-board (e.g., in an operator compartment, such as a cab) of tractor machine 106 or other agricultural machines 2000. In some examples, operators 3061 are remote from the tractor machine 106 or the other agricultural machines 2000 and control the tractor machine 106 or the agricultural machines 2000 through one or more interface mechanisms (e.g., 4018) which are remote from the machines but operatively coupled (e.g., communicatively coupled, such as over networks 3059) to the machines (e.g., 106, 2000).

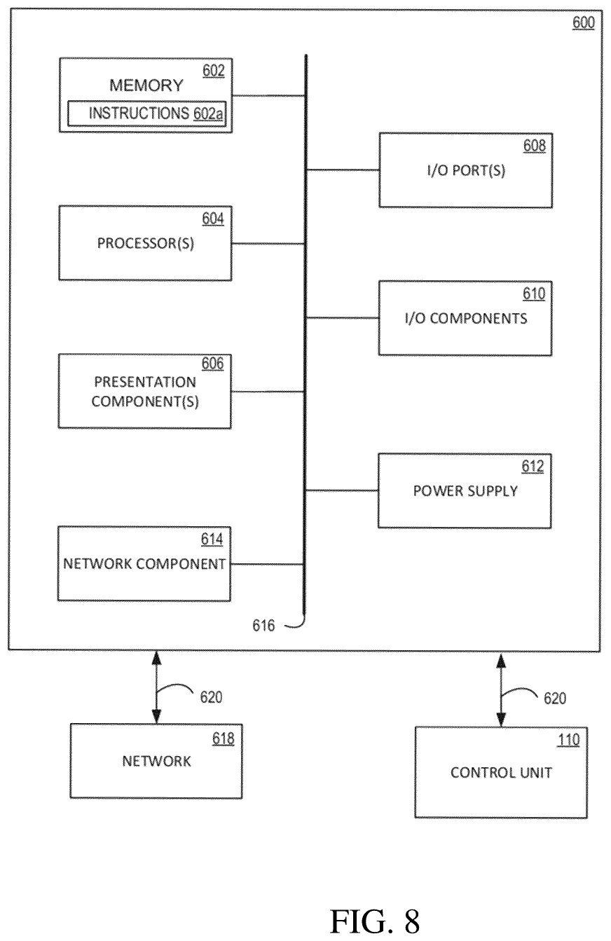

As previously described, items in system 100 can be distributed in various ways. For example, items in system 100 can be distributed in various ways, including ways that differ from the example shown in FIG. 7. For example, but not by limitation, control unit 110, shown in FIG. 7 as being disposed on tractor machine 106, can be located elsewhere, such as at one or more remote computing systems 3000 or on an other agricultural machine 2000. In yet other examples, control unit 110 can be distributed across multiple items of system 100, including for example, across a tractor machine 106, a remote computing system 3000, and an other agricultural machine 2000. In yet other examples, each of the tractor machine 106, a remote computing system 3000, and an agricultural machine 2000 can include a respective control unit 110. Further, for example, but not by limitation, analyzing unit 108, shown in FIG. 8 as being disposed on tractor machine 106, can be located elsewhere, such as at one or more remote computing systems 3000 or on an other agricultural machine 2000. In yet other examples, analyzing unit 108 can be distributed across multiple items of system 100, including for example, across a tractor machine 106, a remote computing system 3000, and an other agricultural machine 2000. In yet other examples, each of the tractor machine 106, a remote computing system 3000, and an agricultural machine 2000 can include a respective analyzing unit 108.

With reference now to FIG. 8, a block diagram of a computing device 600 suitable for implementing various aspects of the disclosure as described. For example, in operation, the computing device 600 is operable with the control unit 110 to control operation of an agricultural work machine or system (e.g. residue system) thereof as described in more detail herein. FIG. 8 and the following discussion provide a brief, general description of a computing environment in/on which one or more or the implementations of one or more of the methods and/or system set forth herein may be implemented. The operating environment of FIG. 8 is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, which perform particular tasks or implement particular abstract data types. Typically, the functionality of the computer readable instructions may be combined or distributed as desired in various environments.

In some examples, the computing device 600 includes a memory 602, one or more processors 604, and one or more presentation components 606. The disclosed examples associated with the computing device 600 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 8 and the references herein to a “computing device.” The disclosed examples are also practiced in distributed computing environments, where tasks are performed by remote-processing devices that are linked through a communications network. Further, while the computing device 600 is depicted as a single device, in one example, multiple computing devices work together and share the depicted device resources. For instance, in one example, the memory 602 is distributed across multiple devices, the processor(s) 604 provided are housed on different devices, and so on.

In one example, the memory 602 includes any of the computer-readable media discussed herein. In one example, the memory 602 is used to store and access instructions 602a configured to carry out the various operations disclosed herein. In some examples, the memory 602 includes computer storage media in the form of volatile and/or nonvolatile memory, removable or non-removable memory, data disks in virtual environments, or a combination thereof. In one example, the processor(s) 604 includes any quantity of processing units that read data from various entities, such as the memory 602 or input/output (I/O) components 610. Specifically, the processor(s) 604 are programmed to execute computer-executable instructions for implementing aspects of the disclosure. In one example, the instructions 602a are performed by the processor 604, by multiple processors within the computing device 600, or by a processor external to the computing device 600. In some examples, the processor(s) 604 are programmed to execute instructions such as those illustrated in the flow charts discussed herein and depicted in the accompanying drawings.

In other implementations, the computing device 600 may include additional features and/or functionality. For example, the computing device 600 may also include additional storage (e.g., removable and/or non-removable) including, but not limited to, magnetic storage, optical storage, and the like. Such additional storage is illustrated in FIG. 8 by the memory 602. In one implementation, computer readable instructions to implement one or more implementations provided herein may be in the memory 602 as described herein. The memory 602 may also store other computer readable instructions to implement an operating system, an application program and the like. Computer readable instructions may be loaded in the memory 602 for execution by the processor(s) 604, for example.

The presentation component(s) 606 present data indications to an operator or to another device. In one example, the presentation components 606 include a display device, speaker, printing component, vibrating component, etc. One skilled in the art will understand and appreciate that computer data is presented in a number of ways, such as visually in a graphical user interface (GUI), audibly through speakers, wirelessly between the computing device 600, across a wired connection, or in other ways. In one example, the presentation component(s) 606 are not used when processes and operations are sufficiently automated that a need for human interaction is lessened or not needed. I/O ports 608 allow the computing device 600 to be logically coupled to other devices including the I/O components 610, some of which is built in. Implementations of the I/O components 610 include, for example but without limitation, a microphone, keyboard, mouse, joystick, pen, game pad, satellite dish, scanner, printer, wireless device, camera, etc.

The computing device 600 includes a bus 616 that directly or indirectly couples the following devices: the memory 602, the one or more processors 604, the one or more presentation components 606, the input/output (I/O) ports 608, the I/O components 610, a power supply 612, and a network component 614. The computing device 600 should not be interpreted as having any dependency or requirement related to any single component or combination of components illustrated therein. The bus 616 represents one or more busses (such as an address bus, data bus, or a combination thereof). Although the various blocks of FIG. 8 are shown with lines for the sake of clarity, some implementations blur functionality over various different components described herein.

The components of the computing device 600 may be connected by various interconnects. Such interconnects may include a Peripheral Component Interconnect (PCI), such as PCI Express, a Universal Serial Bus (USB), firewire (IEEE 1394), an optical bus structure, and the like. In another implementation, components of the computing device 600 may be interconnected by a network. For example, the memory 602 may be comprised of multiple physical memory units located in different physical locations interconnected by a network.

In some examples, the computing device 600 is communicatively coupled to a network 618 using the network component 614. In some examples, the network component 614 includes a network interface card and/or computer-executable instructions (e.g., a driver) for operating the network interface card. In one example, communication between the computing device 600 and other devices occurs using any protocol or mechanism over a wired or wireless connection 620. In some examples, the network component 614 is operable to communicate data over public, private, or hybrid (public and private) connections using a transfer protocol, between devices wirelessly using short range communication technologies (e.g., near-field communication (NFC), Bluetooth® branded communications, or the like), or a combination thereof.

The connection 620 may include, but is not limited to, a modem, a Network Interface Card (NIC), an integrated network interface, a radio frequency transmitter/receiver, an infrared port, a USB connection or other interfaces for connecting the computing device 600 to other computing devices. The connection 620 may transmit and/or receive communication media.

Although described in connection with the computing device 600, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCS, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure, such as controllers or monitors, are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms can include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition can be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores can be local to the systems accessing the data stores, one or more of the data stores can all be located remote form a system utilizing the data store, or one or more data stores can be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality can be distributed among more components. In different examples, some functionality can be added, and some can be removed.

It will be noted that the above discussion has described a variety of different systems, units, components, and interactions. It will be appreciated that any or all of such systems, units, components, and interactions can be implemented by hardware items, such as one or more processors, one or more processors executing computer executable instructions stored in memory, memory, or other processing components, some of which are described elsewhere herein, that perform the functions associated with those systems, units, components, and interactions. In addition, any or all of the systems, units, components, and interactions can be implemented by software that is loaded into a memory and is subsequently executed by one or more processors or one or more servers or other computing component(s), as described elsewhere herein. Any or all of the systems, units, components, and interactions can also be implemented by different combinations of hardware, software, firmware, etc., some examples of which are described elsewhere herein. These are some examples of different structures that can be used to implement any or all of the systems, units components, and interactions described above. Other structures can be used as well.

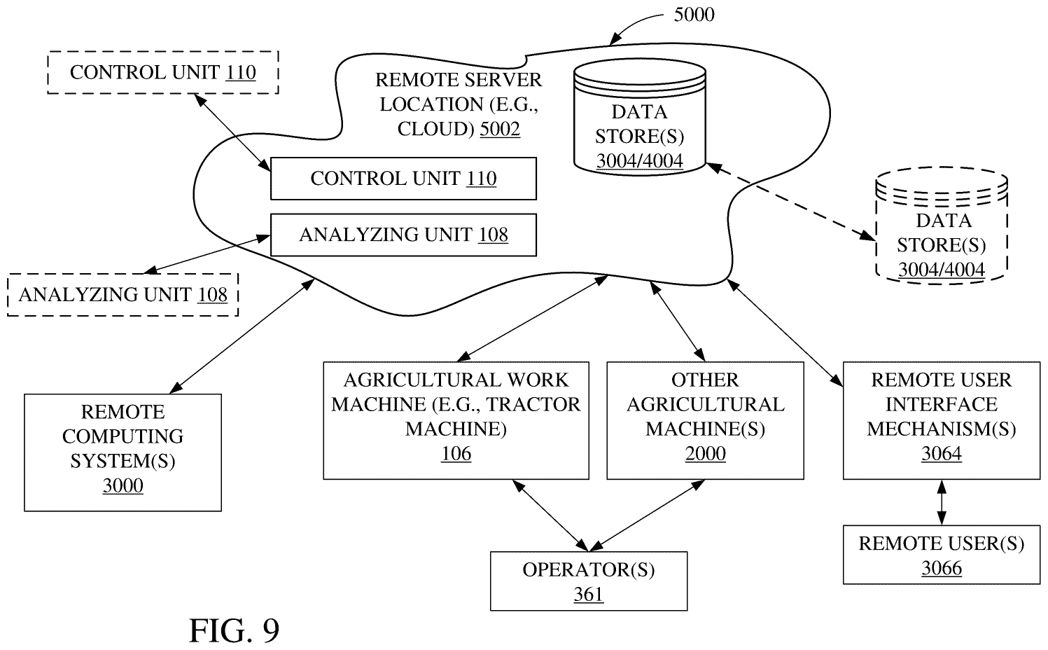

FIG. 9 is a block diagram of a remote server architecture 5000. FIG. 9, also shows agricultural work machine (e.g., tractor machine) 106, one or more remote computing systems 3000, one or more agricultural machines 2000, and one or more remote user interface mechanisms 3064 in communication with the remote server environment. The agricultural work machine 106, remote computing systems 3000, agricultural machines 2000, and remote user interface mechanisms 3064 communicate with elements in a remote server architecture 5000. In some examples, remote server architecture 5000 provides computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and can be accessible through a web browser or any other computing component. Software or components shown in previous figures as well as data associated therewith, can be stored on servers at a remote location. The computing resources in a remote server environment can be consolidated at a remote data center location, or the computing resources can be dispersed to a plurality of remote data centers. Remote server infrastructures can deliver services through shared data centers, even though the services appear as a single point of access for the user. Thus, the components and functions described herein can be provided from a remote server at a remote location using a remote server architecture. Alternatively, the components and functions can be provided from a server, or the components and functions can be installed on client devices directly, or in other ways.

In the example shown in FIG. 9, some items are similar to those shown in previous figures and those items are similarly numbered. FIG. 9 specifically shows that control unit 110, analyzing unit 108, data stores 3004, or data stores 4004, or a combination thereof, can be located at a server location 5002 that is remote from the agricultural work machine 106, remote computing systems 3000, agricultural machines 2000, and remote user interface mechanisms 3064. Therefore, in the example shown in FIG. 9, agricultural work machine 106, remote computing systems 3000, agricultural machines 2000, and remote user interface mechanisms 3064 access systems through remote server location 5002. In other examples, various other items can also be located at server location 5002, such as various other items of system 100.

FIG. 9 also depicts another example of a remote server architecture. FIG. 9 shows that some elements of previous figures can be disposed at a remote server location 5002 while others can be located elsewhere. By way of example, one or more of data store(s) 3004 and 4004 can be disposed at a location separate from location 5002 and accessed via the remote server at location 5002. Similarly, control unit 110 or analyzing unit 108, or both, can be disposed at a location separate from location 1002 and accessed via the remote server at location 1002. Regardless of where the elements are located, the elements can be accessed directly by agricultural work machine 106, remote computing systems 3000, agricultural machines 2000, and remote user interface mechanisms 3064 through a network such as a wide area network or a local area network; the elements can be hosted at a remote site by a service; or the elements can be provided as a service or accessed by a connection service that resides in a remote location. Also, data can be stored in any location, and the stored data can be accessed by, or forwarded to, operators, users, or systems. For instance, physical carriers can be used instead of, or in addition to, electromagnetic wave carriers. In some examples, where wireless telecommunication service coverage is poor or nonexistent, another machine, such as a fuel truck or other mobile machine or vehicle, can have an automated, semi-automated or manual information collection system. As a mobile machine (e.g., agricultural work machine 106, machine 2000) comes close to the machine containing the information collection system, such as a fuel truck prior to fueling, or other mobile machine or vehicle, the information collection system collects the information from the mobile machine (e.g., agricultural work machine 106, machine 2000) using any type of ad-hoc wireless connection. The collected information can then be forwarded to another network when the machine containing the received information reaches a location where wireless telecommunication service coverage or other wireless coverage is available. For instance, a fuel truck, can enter an area having wireless communication coverage when traveling to a location to fuel other machines or when at a main fuel storage location. Other mobile machines or vehicles can enter an area having wireless communication coverage when traveling to other locations or when at another location. All of these architectures are contemplated herein. Further, the information can be stored on a mobile machine (e.g., agricultural work machine 106, machine 2000) until the mobile machine enters an area having wireless communication coverage. The mobile machine (e.g., agricultural work machine 106, machine 2000), itself, can send the information to another network.

It will also be noted that the elements of previous figures, or portions thereof, can be disposed on a wide variety of different devices. One or more of those devices can include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 5000 can include cybersecurity measures. Without limitation, these measures can include encryption of data on storage devices, encryption of data sent between network nodes, authentication of people or processes accessing data, as well as the use of ledgers for recording metadata, data, data transfers, data accesses, and data transformations. In some examples, the ledgers can be distributed and immutable (e.g., implemented as blockchain).

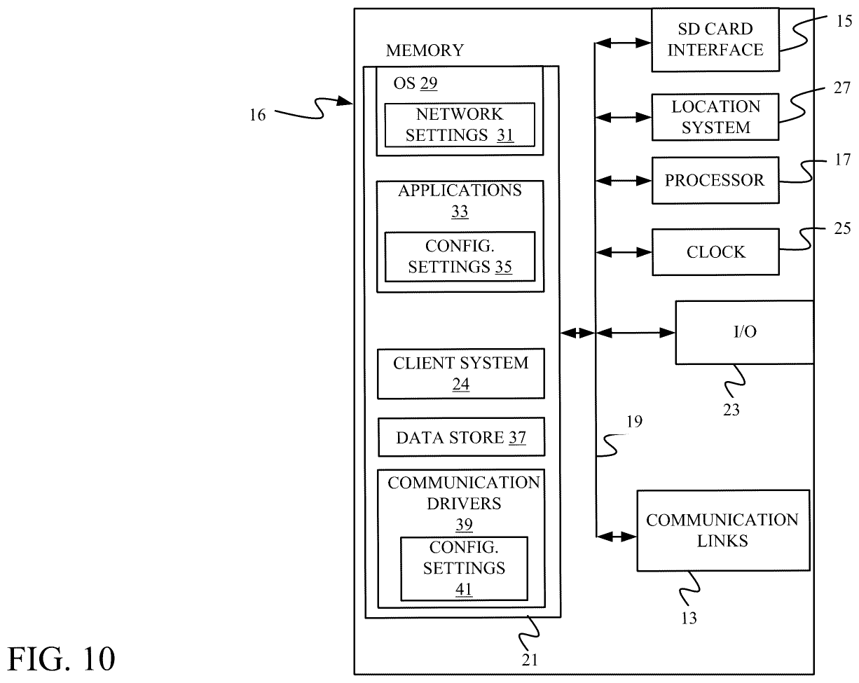

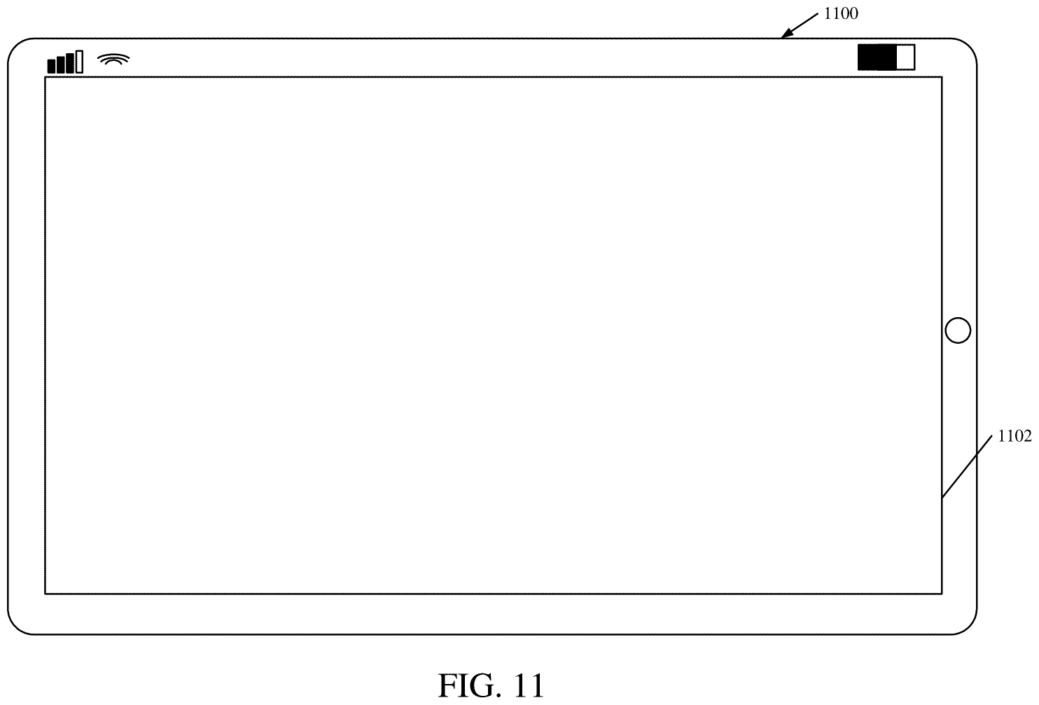

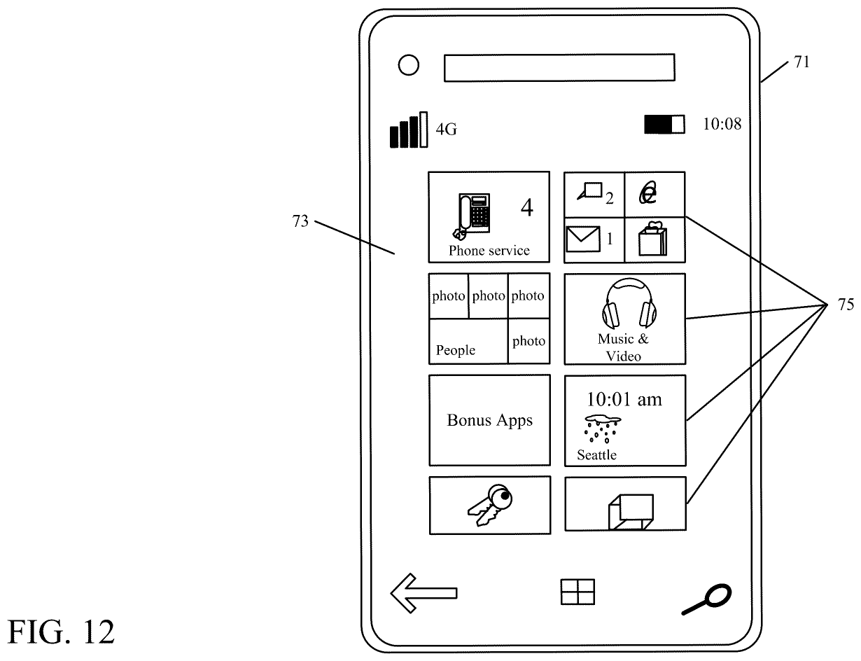

FIG. 10 is a simplified block diagram of one illustrative example of a handheld or mobile computing device that can be used as a user's or client's handheld device 16, in which the present system (or parts of it) can be deployed. For instance, a mobile device can be deployed in the operator compartment of a mobile machine (e.g., agricultural work machine 106, machine 2000) or can be communicably coupled to a mobile machine (e.g., agricultural work machine 106, machine 2000) for use in generating, processing, or displaying the information and outputs discussed above. FIGS. 11 and 12 are examples of handheld or mobile devices.

FIG. 10 provides a general block diagram of the components of a client device 16 that can run some components shown in previous figures, that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other figures) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, client system 24, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 11 shows one example in which device 16 is a tablet computer 1100. In FIG. 11, computer 1100 is shown with user interface display screen 1102. Screen 1102 can be a touch screen or a pen-enabled interface that receives inputs from a pen or stylus. Tablet computer 1100 can also use an on-screen virtual keyboard. Of course, computer 1100 can also be attached to a keyboard or other user input device through a suitable attachment mechanism, such as a wireless link or USB port, for instance. Computer 1100 can also illustratively receive voice inputs as well.

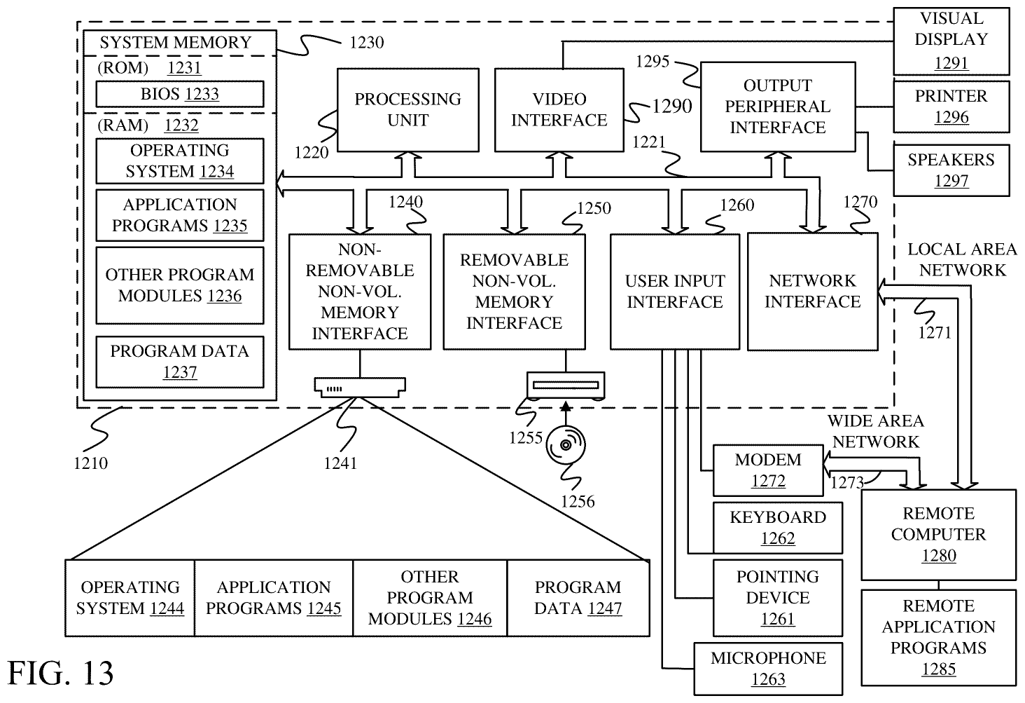

FIG. 12 is similar to FIG. 13 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

FIG. 13 is one example of a computing environment in which elements of previous figures described herein can be deployed. With reference to FIG. 13, an example system for implementing some embodiments includes a computing device in the form of a computer 1210 programmed to operate as discussed above. Components of computer 1210 can include, but are not limited to, a processing unit 1220 (which can comprise processors or servers from previous figures), a system memory 1230, and a system bus 1221 that couples various system components including the system memory to the processing unit 1220. The system bus 1221 can be any of several types of bus structures including a memory bus or memory controller, a peripheral bus, and a local bus using any of a variety of bus architectures. Memory and programs described with respect to previous figures described herein can be deployed in corresponding portions of FIG. 13.

Computer 1210 typically includes a variety of computer readable media. Computer readable media can be any available media that can be accessed by computer 1210 and includes both volatile and nonvolatile media, removable and non-removable media. By way of example, and not limitation, computer readable media can comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media can embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220. By way of example, and not limitation, FIG. 13 illustrates operating system 1234, application programs 1235, other program modules 1236, and program data 1237.

The computer 1210 can also include other removable/non-removable volatile/nonvolatile computer storage media. By way of example only, FIG. 13 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), quantum computers, etc.

The drives and their associated computer storage media discussed above and illustrated in FIG. 13 provide storage of computer readable instructions, data structures, program modules and other data for the computer 1210. In FIG. 13, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user can enter commands and information into the computer 1210 through input devices such as a keyboard 1262, a microphone 1263, and a pointing device 1261, such as a mouse, trackball or touch pad. Other input devices (not shown) can include a joystick, game pad, satellite dish, scanner, or the like. These and other input devices are often connected to the processing unit 1220 through a user input interface 1260 that is coupled to the system bus, but can be connected by other interface and bus structures. A visual display 1291 or other type of display device is also connected to the system bus 1221 via an interface, such as a video interface 1290. In addition to the monitor, computers can also include other peripheral output devices such as speakers 1297 and printer 1296, which can be connected through an output peripheral interface 1295.

The computer 1210 is operated in a networked environment using logical connections (such as a controller area network—CAN, local area network—LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules can be stored in a remote memory storage device. FIG. 14 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of the systems and methods described herein. It is intended to include all such modifications and alterations in so far as they come within the scope of the appended claims or the equivalents thereof.

What is claimed is:

1. An agricultural system comprising:
one or more processors; and
memory storing instructions executable by the one or more processors that, when executed by the one or more processors, configure the agricultural system to:
obtain an image captured by an imaging device during an agricultural operation performed by an agricultural work machine, the image indicating a characteristic;
segment the image to generate a segmented image having a plurality of cells and selectively size each cell of the plurality of cells according to one or more cell size criteria;
determine one or more values of the characteristic based on the segmented image; and
control an operating parameter of the agricultural work machine based, at least, on the one or more values of the characteristic.

2. The agricultural system of claim 1, wherein the agricultural work machine comprises a harvester, wherein the agricultural operation comprises a harvesting operation, wherein the characteristic is residue performance, and wherein the instructions, when executed by the one or more processors, further configure the agricultural system to control an operating parameter of a residue system of the harvester based on the one or more values of residue performance.

3. The agricultural system of claim 1, wherein a cell size criterion, of the one or more cell size criteria, comprises a level of obscurant and wherein the instructions, when executed by the one or more processors, further configure the agricultural system to determine a respective level of obscurant corresponding to each cell and to size each cell based, at least, on the respective level of obscurant.

4. The agricultural system of claim 1, wherein a cell size criterion, of the one or more cell size criteria, comprises a distance from the imaging device and wherein the instructions, when executed by the one or more processors, further configure the agricultural system to determine a respective distance from the imaging device corresponding to each cell and to size each cell based, at least, on the respective distance from the imaging device.

5. The agricultural system of claim 1, wherein a cell size criterion, of the one or more cell size criteria, comprises a variability of an additional characteristic and wherein the instructions, when executed by the one or more processors, further configure the agricultural system to determine the variability of the additional characteristic and to size each cell based, at least, on the variability of the additional characteristic.

6. The agricultural system of claim 5, wherein the additional characteristic comprises material flow.

7. The agricultural system of claim 1, wherein a cell size criterion, of the one or more cell size criteria, comprises a confidence level and wherein the instructions, when executed by the one or more processors, further configure the agricultural system to determine a respective confidence level corresponding to each cell and to size each cell based, at least, on the respective confidence level.

8. The agricultural system of claim 7, wherein the instructions, when executed by the one or more processors, further configure the agricultural system to determine each respective confidence level based on one or more of: (i) an obscurant level corresponding to the corresponding cell; and (ii) a distance of the corresponding cell from the imaging sensor.

9. The agricultural system of claim 1, wherein the instructions, when executed by the one or more processors, further configure the agricultural system to dynamically adjust a size of one or more of the plurality of cells based on a change to the one or more cell size criteria as the imaging device acquires more images during the agricultural operation.

10. The agricultural system of claim 1, wherein the cell size comprises at least one of a length, a width, an angle, an area, a radius, or a combination thereof.

11. The agricultural system of claim 1, wherein the instructions, when executed by the one or more processors, further configure the agricultural system to:
identify a respective confidence value for each cell of the plurality of cells based on one or more confidence criteria; and
control the operating parameter of the agricultural work machine based, at least, on the respective confidence value for each cell of the plurality of cells and the one or more values of the characteristic.

12. The agricultural system of claim 11, wherein the one or more confidence criteria comprise at least one of an obscurant level, a distance from the imaging device, or a combination thereof.

13. The agricultural system of claim 11, wherein the instructions, when executed by the one or more processors, further configure the agricultural system to:
interpolate one or more cells of the plurality of cells based, at least, on the respective confidence value of the one or more cells of the plurality of cells.

14. A computer implemented method of controlling an agricultural work machine, the computer implemented method comprising:
obtaining an image captured by an imaging device during an agricultural operation performed by an agricultural work machine, the image indicating a characteristic;
segmenting the image to generate a segmented image having a plurality of cells and selectively sizing each cell of the plurality of cells according to one or more cell size criteria;
determining one or more values of the characteristic based on the segmented image; and
control an operating parameter of the agricultural work machine based, at least, on the one or more values of the characteristic.

15. The computer implemented method of claim 14 and further comprising determining a respective value of each of the one or more cell size criteria for each cell of the plurality of cells and wherein selectively sizing each cell of the plurality of cells comprises selectively sizing each cell of the plurality of cells based on the respective level of each of the one or more cell size criteria for each cell of the plurality of cells.

16. The computer implemented method of claim 14, wherein the one or more cell size criteria comprise one or more of obscurant, distance from the imaging device, variability of an additional characteristic, and confidence, wherein determining a respective value of each of the one or more cell size criteria for each cell comprises determining, for each cell, at least one of a respective level of obscurant, a respective distance from the imaging device, a respective level of variability of the additional characteristic, and a respective confidence value.

17. The computer implemented method of claim 14, wherein the one or more cell size criteria includes proximity to a cut edge of the agricultural work machine, the computer implemented method further comprising:
determining, for each cell, a respective proximity to a cut edge of the agricultural work machine; and
wherein selectively sizing each cell comprises selectively sizing each cell based, at least, on the respective proximity to the cut edge corresponding to each cell.

18. The computer implemented method of claim 14 and further comprising:
determining a respective confidence value for each cell of the plurality of cells based on one or more confidence criteria; and
wherein controlling the operating parameter of the agricultural work machine comprises controlling the operating parameter of the agricultural work machine based, at least, on the respective confidence value for each cell of the plurality of cells and the one or more values of the characteristic.

19. The computer implemented method of claim 18, wherein determining a respective confidence value for each cell comprises determining the respective confidence value for each cell based on one or more of: (i) an obscurant level corresponding to the corresponding cell; and (ii) a distance of the corresponding cell from the imaging sensor.

20. An agricultural system comprising:
one or more processors; and
memory storing instructions executable by the one or more processors that, when executed by the one or more processors, configure the agricultural system to:
obtain an image captured by an imaging device during an agricultural operation, the image indicating a performance parameter;
segment the image to generate a segmented image having a plurality of cells and selectively size each cell of the plurality of cells according to one or more cell size criteria;
determine a value of the performance parameter based on the segmented image;
determine a confidence level corresponding to the segmented image based on one or more confidence criteria; and
control an operating parameter of an agricultural work machine based, at least, on the value of the performance parameter and the confidence level.
